(19) United States
(12) Patent Application Publication
(10) Pub. No.: US 2011/0239282 A1
(43) Pub. Date: Sep. 29, 2011

(54) Method and Apparatus for Authentication and Promotion of Services

(75) Inventors: Bror Lennart Svarfvar, Littoinen (FI); Terho Otso Tapio Kaikuranta, Piispanristi (FI); Sampo Juhani Sovio, Riihimaki (FI)

(73) Assignee: NOKIA CORPORATION, Espoo (FI)

(21) Appl. No.: 12/796,571

(22) Filed: Jun. 8, 2010

Related U.S. Application Data
(63) Continuation-in-part of application No. 12/732,824, filed on Mar. 26, 2010.

(51) Int. Cl. H04L 9/32

(52) U.S. Cl. 726/5; 726/8

(57) ABSTRACT

An approach is provided for authenticating services at a device. An authentication request from a services platform is received at a device. Local credentials to authenticate access to a storage are retrieved. The access to the storage is authenticated based, at least in part, on the local credentials. If authenticated, it is determined that account information for the services platform is in the storage. The account information includes authentication credentials associated with the services platform, a security policy associated with the services platform, or a combination thereof. A response to the authentication request is generated based, at least in part, on the account information.

### CROSS-REFERENCE TO RELATED APPLICATIONS

This application claims benefit as a Continuation-in-Part of application Ser. No. 12/732,824 filed Mar. 26, 2010, the entire contents of which are hereby incorporated by reference as if fully set forth herein, under 35 U.S.C. §120.

### BACKGROUND

Service providers and device manufacturers (e.g., wireless, cellular, etc.) are continually challenged to deliver value and convenience to consumers by, for example, providing compelling network services. However, many of these services, in general, require users to proactively take steps in setting up and authenticating via one or more accounts at multiple network sites. Many of these registration schemes to set up accounts require a plethora of information from the user, deterring the user from activating and/or utilizing the services because the users do not wish to spend time registering.

Further, the continual develop of rich, on-line services confers great benefit to users in terms of breadth of offerings. Ironically, the volume of available services can overwhelm users, and effectively result in numerous services being overlooked. Moreover, little effort has been made to integrate these on-line services, thereby encumbering such users with, for instance, the task of managing a multitude of authenticating procedures. As a result, users are even more reluctant to partake in these services.

### Some Example Embodiments

Therefore, there is a need for an approach for conveniently authenticating users across multiple networks, while facilitating the promotion of different services.

According to one embodiment, a method comprises receiving an authentication request from a services platform. The method also comprises retrieving local credentials to authenticate access to a storage. The method further comprises authenticating the access to the storage based, at least in part, on the local credentials. The method additionally comprises, if authenticated, determining that account information for the services platform is in the storage, the account information including authentication credentials associated with the services platform, a security policy associated with the services platform, or a combination thereof. The method also comprises generating a response to the authentication request based, at least in part, on the account information.

According to another embodiment, an apparatus comprising at least one processor, and at least one memory including computer program code, the at least one memory and the computer program code configured to, with the at least one processor, cause, at least in part, the apparatus to receive, at the apparatus, an authentication request from a services platform. The apparatus is also caused to retrieve local credentials to authenticate access to a storage. The apparatus is further caused to authenticate the access to the storage based, at least in part, on the local credentials. The apparatus is additionally caused to, if authenticated, determine that account information for the services platform is in the storage, the account information including authentication credentials associated with the service platform, a security policy associated with the service platform, or a combination thereof. The apparatus is also caused to generate a response to the authentication request based, at least in part, on the account information.

According to another embodiment, a computer-readable storage medium carrying one or more sequences of one or more instructions which, when executed by one or more processors, cause, at least in part, an apparatus to receive, at a apparatus, an authentication request from a service platform. The apparatus is also caused to retrieve local credentials to authenticate access to a storage. The apparatus is further caused to authenticate the access to the storage based, at least in part, on the local credentials. The apparatus is additionally caused to, if authenticated, determine that account information for the service platform is in the storage, the account information including authentication credentials associated with the service platform, a security policy associated with the service platform, or a combination thereof. The apparatus is also caused to generate a response to the authentication request based, at least in part, on the account information.

According to another embodiment, an apparatus comprises means for receiving, at the apparatus, an authentication request from a service platform. The apparatus also comprises means for retrieving local credentials to authenticate access to a storage. The apparatus further comprises means for authenticating the access to the storage based, at least in part, on the local credentials. The apparatus additionally comprises means for, if authenticated, determining that account information for the service platform is in the storage, the account information including authentication credentials associated with the service platform, a security policy associated with the service platform, or a combination thereof. The apparatus also comprises means for generating a response to the authentication request based, at least in part, on the account information.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing a single sign-on solution to authenticating services, content delivery and content promotion, according to one embodiment;

FIG. 2 is a diagram of the components of user equipment capable of providing a single sign-on solution to authenticating services, content delivery and content promotion, according to one embodiment;

FIG. 3 is a flowchart of a process for authenticating with a remote platform using local credentials, according to one embodiment;

FIG. 4 is a ladder diagram of a process for authenticating with a remote platform using credentials local to a user device, according to one embodiment;

FIG. 5 is a diagram of a user interface utilized in the processes of FIG. 3, according to one embodiment;

FIG. 6 is a flowchart of a process for supporting interaction between a user, a services platform and one or more social network sites, according to one embodiment;

FIGS. 7A-7C and 8A-8D are flowcharts of processes for content delivery to one or more users and updating a services platform and one or more social network sites, according to one embodiment;

FIGS. 9A-9F are diagrams of a user interface utilized in the processes of FIG. 6, according to one embodiment;

FIG. 10 is a diagram of hardware that can be used to implement an embodiment of the invention;

FIG. 11 is a diagram of a chip set that can be used to implement an embodiment of the invention; and

FIG. 12 is a diagram of a mobile terminal (e.g., handset) that can be used to implement an embodiment of the invention.

### DESCRIPTION OF SOME EMBODIMENTS

Examples of a method, apparatus, and computer program for providing a single sign-on solution for content delivery and content promotion are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

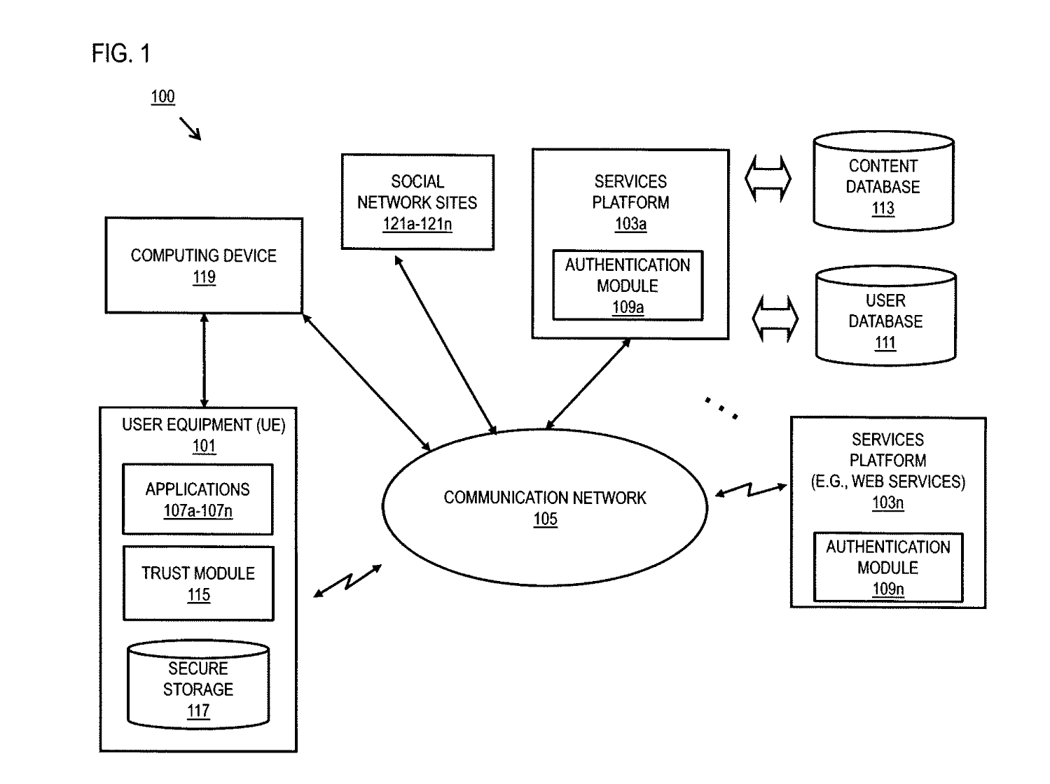

FIG. 1 is a diagram of a system capable of providing a single sign-on solution to authenticating services, content delivery and content promotion, according to one embodiment. Network services, such as media services (e.g., music services, video services, photo services, etc.), navigation services, gaming services, and the like are increasingly being offered to users who can engage in these services using their devices. Some of these services require the use of an authentication approach. As such, the user may be required to activate an account and utilize the account when dealing with the services. Activation of such accounts may include collecting a variety of information from the user, such as the user's name, age, contact information, user name, password, etc. Moreover, activation may be time consuming and/or complex, thereby resulting in users not partaking in or otherwise utilizing or subscribing to the services. It is noted that service providers may have invested heavily in the development of such services; the return on this investment can be undermined if users are reluctant to even try the service because of the need to activate a user account for use of the service. In particular, users often fallback to specifying username/pas sword combinations or other like authentication credentials that are often repetitive, similar, or otherwise insecure because the users may be overwhelmed the number of accounts they have created. For example, many people generate accounts based on a username, such as a user name associated with the user's actual name that can be easily guessed by a potential hacker. Moreover, if this name is taken, users often rely on modifiers (e.g., adding a number) to alter the username used with the service. Thus, users may select authentication credentials (e.g., user names and passwords) that are similar to other usernames that the user has previously used, leading to decreased security. Further, the authentication method provides simple and seamless interaction between user's services platform and social network sites. This ability can encourage broader utilization of such services as well as provide opportunities for sharing and promoting content among different users. Social network sites can be located external to services platform and/or within the services platform.

Further, once a user has authentication parameters set in association with the service provider, it can be difficult for the user to remember the username. This may occur when, for instance, a regular or common username is only lightly modified (e.g., by merely adding a number as described above). Thus, the user may forget which username is associated with which service. In another example case, if the user is forgetful of a previously registered username and/or password because combination is complex (e.g., because the service requires certain minimum standards), the user may write the username and/or password in a document or in another location where the user can retrieve it, thereby leading to potential comprise of the information.

Other insecurities can additionally be caused during the transmission of authentication credentials such as a username and/or password. This is because many hackers attempt to solicit the username and/or password of users for sites using a well known technique called phishing. Using this method, the hacker's system masquerades as a trusted entity (e.g., a bank, a store, etc.) and requests the username and/or password or other credentials from the user. If the user enters the username and/or password, the hacker can use the credentials to sign onto the actual service associated with the credentials. This security threat is undesirable to users as well as service providers.

To address this problem, a system 100 of FIG. 1 introduces the capability to provide a single sign-on solution to authenticating services locally at user equipment. With this approach, authentication credentials of one or more services are stored on storage of the user equipment (UE 101). A local authentication method is used to provide access to the authentication credentials. Then, a response (e.g., a response signal) is sent to one or more services platform 103a-103n (also collectively referred to as services platform 103) that requested the authentication to indicate that the user's credentials are valid and, therefore, the user is allowed access to the service. In addition or alternatively, the user's credentials may be automatically sent to the services platform 103 for direct authentication. In one embodiment, the system 100 authenticates the services platform 103 to ensure that that services platform 103 is authorized to receive the user's credentials before transmitting them. The services platform 103 can be providing services to the user of the UE 101. The response can be sent via a communication network 105 to the services platform 103.

Application(s) 107 (also referred to as applications 107 or application 107) of the UE 101 can request services from the services platform 103. One or more applications 107 can be executing on the UE 101. Applications 107 can be computer software designed to help a user perform one or more tasks. Examples of applications 107 include media presentation and/or creation (e.g., creation and/or presentation of images, video, audio, etc.) word processors, spreadsheets, database manipulation, web browsers, games, purchasing software, etc. Some of these applications 107 request services from the services platform 103.

These services can be provided to each of the applications 107 that request the services from the services platform 103 or may provide the services to the applications 107 based on one or more forms of authentication via one or more authentication modules 109a-109n (also collectively referred to as authentication module 109). The services platform 103 can be associated with a user database 111 that is used to determine what services are available to a registered user. The user database 111 includes one or more identifiers of the user and/or the user's UE 101 or components of the user's UE 101. As such, a data structure can include one or more identifiers of the user, the UE 101 or other devices associated with the account as well as rights associated with the user (e.g., licenses for the user to download or use one or more services or content). Further, the rights associated with the user can differ based on one or more security policies requesting one or more different types of local authentication. For example, one set of rights may be associated with a code-based local authentication, while another set of rights is associated with a biometric data based local authentication. Services and content associated with the services can be stored in a content database 113 and provided to the user via the communication network 105. The content database 113 and/or the user database 111 can be located external to the services platform 103 and/or within the services platform 103. Furthermore, social network site(s) 121 (also referred to as social network sites 121 or social network site 121) focus on building and reflecting of social networks or social relations among people, e.g., who share interests and/or activities. Social network site accordingly retain information relating to representation of each member (often a profile), his/her social links, and a variety of additional services accessing by the members. Most social network sites are web based and provide means for users to interact over the internet, such as e-mail and instant messaging. Social network sites allow users to share ideas, content, activities, events, and interests within their individual networks. There are many types of social network sites some of which contain category places (such as former school-year or classmates), means to connect with friends (usually with self-description pages) and a recommendation system linked to trust. Example of social network sites include OVI®, Facebook®, Bebo®, Twitter®, MySpace®, LinkedIn® and/or the like. Further, the authentication results can be considered as a personal digital key for obtaining internet based services available, for example, at one or more services platform 103 and/or one or more social network sites 121. Furthermore, the personal digital key can be utilized for obtaining one or more other internet based services. Moreover, the authentication method can prevent other users from accessing one or more user account, which they are not authorized to access. In other words, it can reduce and/or eliminate a possibility of hackers breaking into and/or accessing one or more user accounts they are not authorized to access.

Different approaches of authentication may be used by the authentication module 109 to determine whether the user should have access to the services. For example, authentication can be based on a username and/or password model, a security token, one or more security certificates, etc. Further, authentication procedures can be offloaded to a trust module 115 of the UE 101 and a confirmation signal is received by the authentication module 109 to determine that the user has access to the services. When a request for services is received at the services platform 103, the authentication module 109 can cause a transmission to be sent to the applications 107 to request that the applications 107 determine that the user should have access to the services available at the services platform 103.

The applications 107 receive the authentication request from the services platform 103. The applications 107 then causes retrieval of local credentials to authenticate access to a secure storage 117 associated with the UE 101. In certain embodiments, the secure storage 117 is a storage with one or more security features (e.g., encryption of files, encryption of a file system, etc). The retrieval of the local credentials and local authentication of the user can be accomplished using the trust module 115 or the applications 107. The trust module 115 can retrieve the local credentials by causing a presentation of a prompt for a personal identity number (PIN), a local username and/or password, biometric information, or other methods of authentication to a user. The user then provides the local credentials to the UE 101 via an input mechanism such as a keypad, keyboard, touch screen interface, biometric sensor, camera, etc. In some scenarios, a lock state is caused during the prompting. In this state, the UE 101 functions are limited until the local credentials are entered, a predetermined time passes, a cancellation input is entered, or the like. If the local credentials are not entered, the requested service is not retrieved from the services platform 103. Otherwise, the trust module 115 receives the local credentials and compares the local credentials to credentials stored on the secure storage 117 or another memory of the UE 101. If the credentials match, or match, at least in part, to a threshold level, the trust module 115 sends a signal to the services platform 103 that the user has been authenticated. This signal can include a response that includes authentication credentials stored on the secure storage 117 that are associated with the services platform 103. The authentication credentials can additionally be a response formulated by the trust module 115 with a code known to the services platform 103. For example, the trust module 115 can receive a parameter with the authentication request that can be used in conjunction with a key stored on the UE 101 to generate the response. In certain scenarios, because local authentication is used, a simpler authentication mechanism may be used at the authentication module 109. For example, the authentication module 109 may simply check that a response is signed via one or more set of credentials. As such, the back-end processing at the services platform 103 can be reduced, which in turn saves computing resources and network bandwidth for supporting the processing.

In other embodiments, the response can be an unsecure acknowledgement that the user has been authenticated with one or more methods. The authentication request can determine the local method of authentication. Additionally or alternatively, a policy for determining authentication methods associated with the service can be used to determine the local authentication method. The policy can be stored in the secure storage 117 or another memory of the UE 101. The policy can associate a service of the services platform 103 with one or more authentication methods. For example, a first level of authentication may be a PIN code and a second level of authentication may be a biometric (e.g., fingerprint, iris, etc.) scan. As such, one services platform 103a may be associated with the first level of authentication while another services platform 103n may be associated with the second level of authentication. Thus, the methods of authentication can be determined by the trust module 115 by determining the policy associated with the services platform 103. Moreover, the trust module 115 can authenticate with the services platform 103 to verify that the services platform 103 is authentic. This can be accomplished by retrieving an identifier, such as an address (e.g., a uniform resource locator) associated with the services platform 103.

Further, a security policy can be set and used to determine the contents of the response to the services platform 103. One such policy can include transmitting an unsecured signal to the services platform 103. Another policy can include a form of key authentication where the authentication request includes information (e.g., a certificate) that the trust module 115 uses in conjunction with a key associated with the user, UE 101, secure storage 117, etc. to generate a secure response. The response is then determined to be valid or invalid at the services platform 103 to determine whether the services platform 103 should provide one or more requested services to the UE 101.

Additionally or alternatively, when services platform 103 initiates an authentication request to the applications 107, the applications 107 and/or trust module 115 can determine that an entry does not yet exist in the secure storage 117 for the services platform 103. In this scenario, the trust module 115 can generate a request to the services platform 103 to create a new account. The request can include new account information including authentication credentials such as username, password, etc., predetermined registration information (e.g., identifiers associated with the UE 101, information stored on the UE 101, etc.), a combination thereof, or the like. In certain embodiments, the username is unnecessary and an identifier of the UE 101 or hardware associated with the UE 101 (e.g., an international mobile equipment identity (IMEI), an international mobile subscriber identity (IMSI), a telephone number, a serial number, an e-mail address stored in the UE 101 etc.), is utilized to identify the account. In this manner, the user need not remember a username for the account. The authentication module 109 of the services platform 103 can then register the user/UE 101 using a user account in a user database 111. Further, the account can be associated with one or more rights or licenses. The user can purchase or acquire additional rights or licenses for the UE 101 or for use with the account. Additionally, the services platform 103 or other input to the UE 101 can be utilized to set up a security policy for the new account. The security policy can be stored on the secure storage 117 and include what type of information to be sent to the services platform 103 for authentication. Moreover, the security policy may be associated with one or more keys to encrypt responses to the services platform 103. Further, the security policy can include sending of the username and/or password information stored in the secure storage 117 to the services platform 103. In certain embodiments, the local credentials used to authenticate the user locally on the device are not sent to the services platform 103.

In one embodiment, a computing device 119 is utilized to generate a new account or transfer account information from one UE 101 to another UE 101. In one scenario, the computing device 119 may be at the point-of-sale of the UE 101 or the point-of-sale of services for the UE 101. For example, the user may purchase a service for the UE 101 or a an identifier that can be associated with the UE 101 such as a Subscriber Identity Module (SIM) that can be used to provide services to the UE 101. When acquiring a new UE 101 or SIM, the user may fill out registration information, which can be copied to a contact card storage on the user's UE 101 or another module (e.g., a SIM card) when the UE 101 is powered on (e.g., the first time the UE 101 is powered on). If certain registration information (e.g., an e-mail address) is missing, the registration information may be generated (e.g., a new e-mail address created and assigned to the user) for the UE 101, if applicable. Additionally or alternatively local credentials can be generated (e.g., a default PIN can be generated and communicated to the user) and the user may alter or be requested to alter the local credentials the first time local credentials are used or during an activation process for the UE 101. In another scenario, the computing device 119 may be utilized to copy the local credentials from the contact card of a used UE 101 to the user's new or current UE 101. In this scenario, the information in the secure storage 117 including the local credentials can be transferred to the current UE 101.

In one embodiment, the UE 101 requests and receives content from the services platform 103. The services platform 103 authenticates the user and/or the UE 101; and upon successful authentication and acceptance of content delivery terms by the user of UE 101, the services platform 103 delivers the content to the UE 101. Further, the services platform 103 provides the user of UE 101 with options for connecting to one or more social network sites 121. As part of the activities of a social network site, users can post recent events and commentary about themselves or others. For example, sharing information about content (e.g., music, video, games, etc.) is a popular activity. However, traditionally, if a user posted information about a particular content, there is no convenient, seamless way for another user (e.g., “friend” of the user) to acquire the content. In other words, this other user would need to inquire with the user where and how—e.g., what link or website to visit—to obtain the content. In recognition of this issue, services platform 103 provides an approach, in conjunction with the respective social network sites 121, to update the user's content consumption history information with consumed content on the user's “wall.” That is, the user can choose to make the same content available to other users. As will be more detailed later, the process of authenticating the user to log on to one or more social network sites 121 can be leveraged to conveniently log on the user to the services platform 103, where the content can be acquired.

Furthermore, the users and/or content providers can utilize the social network sites to promote contents. Users can promote one or more content they consumed and/or their one or more favourite content via one or more social network sites 121. To encourage such promotions, content providers at services platform 103 can create incentive programs for users to promote users' consumed or users' favourite content. The incentive programs can include rewards offered to promoting users. The rewards can include monetary awards, one or more credit points to be used for obtaining more content and/or the like. Additionally, the users and/or the content providers can organize competition programs whereby the users compete to collect most points for promoting one or more content. For example, if a user promotes a certain content on the user's social network site 121 and another user, a visiting user or user 2, initiates obtaining the same content via the user's social network site 121, the services platform 103 attributes a reward to the user's services platform 103 account and/or to the user's social network site 121 account. As another example, if a third user visits the user 2 social network site 121 and initiates obtaining the same content via user 2 social network site 121, then the services platform 103 attributes a reward to the user 2 social services platform 103 account and/or to the user 2 social network site 121 account. Subsequent user content consumptions and/or user content promotions can follow above rewarding examples and/or other variations.

In some embodiments, a platform security implementation of the UE 101 allows for secure execution of signed applications 107 (e.g., the trust module 115). For example, the NOKIA BB5 based platforms support an implementation of secure storage 117 that can include highly confidential information such as SIM lock specific information as well as keys for Digital Rights Management (DRM). The NOKIA BB5 based secure storage 117 can be implemented separately from security provided by a service provider and/or operator providing access to the communication network 105. When an account is created, authentication information (e.g., a username/password for a services platform 103) is stored in the secure storage 117 as previously detailed. Then, when the services platform 103 requests the authentication information, the user need simply locally unlock the secure storage 117 to allow the applications 107 to send verification that the user has access to the services of the services platform 103. An advantage of this approach is compatibility with current services platforms 103a-103n because the authentication information passed to the services platform 103 need not be modified. Thus, the system 100 includes a means for locally verifying access to one or more services on a services platform 103.

When the services platform 103 receives the authentication information, the services platform 103 can parse the authentication and determine a level of authentication for the user. Each level of authentication can be associated with one or more rights or licenses available to the user. For example, one right may be to download free music, another right may be to conduct one or more monetary transactions or monetary transactions above a predetermined threshold value, yet another right may be a right to purchase an application, or the like. The levels of authentication may be included in a response from the UE 101 to a request for the authentication information. As such, the local authentication level can be used to determine what rights are provided to the user. Thus, the system 100 includes a means for locally determining access levels of rights to services on a services platform 103.

In one embodiment, the services platform 103 uses an identifier of the UE 101 (e.g., a telephone number) as well as the authentication information in a response from the UE 101 to determine whether the UE 101 should be provided with one or more services. The identifier of the UE 101 is used to determine whether the UE 101 should have access to the services, while the response is used to determine that the user of the UE 101 should have access to the UE 101. In this manner, the access to the account can be tied both to the UE 101 and the user. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 101 can support any type of interface to the user (such as “wearable” circuitry, etc.).

By way of example, the UE 101, and services platforms 103 communicate with each other and other components (e.g., other UEs 101) of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the applications 107 and the services platform 103 may interact according to a client-server model. According to the client-server model, a client process sends a message including a request to a server process, and the server process responds by providing a service (e.g., maps, games, shopping, media download, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

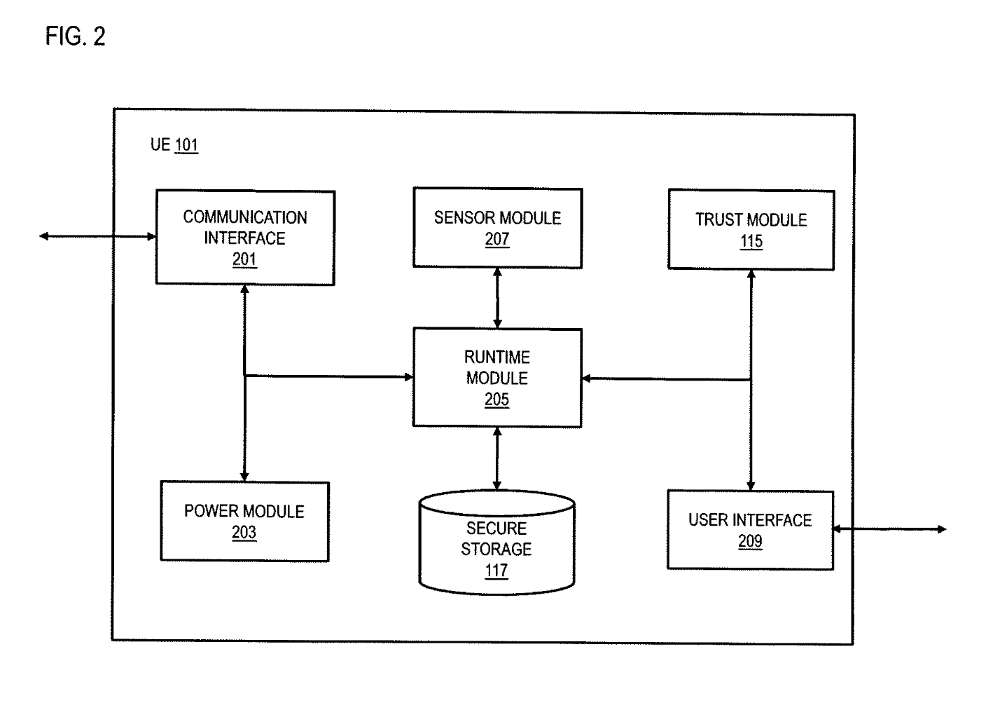

FIG. 2 is a diagram of the components of user equipment capable of providing a single sign-on solution to authenticating services, according to one embodiment. By way of example, the UE 101 includes one or more components for providing a single sign-on solution using local authentication. It is contemplated that the functions of these components may be combined in one or more components or performed by other components of equivalent functionality. In this embodiment, the UE 101 includes a communication interface 201, a power module 203, a runtime module 205, a secure storage 117, a trust module 115, a sensor module 207, and a user interface 209.

In one embodiment, the communication interface 201 can be used to communicate with the services platforms 103, other UEs 101, or other devices on the communication network 105. Certain communications can be via methods such as an internet protocol, messaging, or any other communication method (e.g., via the communication network 105). In some examples, the UE 101 can send a query or a request to utilize services to a services platform 103 via the communication interface 201. The services platform 103 may then send a response back via the communication interface 201 including a request for authentication of the user of the UE 101. Other components of the UE 101 can perform the authentication as described and a response can be sent to the services platform 103 via the communication interface 201. Moreover, once authenticated, the services platform 103 can provide one or more services or content (e.g., the requested service) to the UE 101.

The power module 203 provides power to the UE 101. The power module 203 can include any type of power source (e.g., battery, plug-in, etc.). Additionally, the power module 203 can provide power to the components of the UE 101 including processors, memory, and transmitters.

The user interface 209 can include various methods of communication. For example, the user interface 209 can have outputs including a visual component (e.g., a screen), an audio component, a physical component (e.g., vibrations), and other methods of communication. User inputs can include a touch-screen interface, a scroll-and-click interface, a button interface, a microphone, etc. Moreover, the user interface 209 may be used to prompt the user to enter local credentials (e.g., a PIN code, biometric sensor input, etc.) and receive local credentials from the user. The applications 107 executing on the runtime module 205 can additionally lock the user interface 209 while requesting the local credentials.

The trust module 115 can be utilized to generate information used to conduct local authentication or another device (e.g., a computing device at a point of purchase). For example, the trust module 115 can be used to set up local credentials used for authentication. Different types of local credentials can be associated with one or more services platforms 103. Local credentials can be entered when the user purchases the UE 101 (e.g., during initialization) or a hardware identifier associated with the UE 101 (e.g., a SIM card). Personal information such as name, e-mail, address, phone number, etc. can be stored in the secure storage 117. Further, in certain embodiments, this information is transferred from a SIM card to a secure storage 117 on the UE 101 when a new SIM card is inserted to the UE 101. In other embodiments, the local credentials can unlock a SIM card lock, which can be used for authentication. As previously noted, the local credentials can include a PIN code, a local username and/or password, biometric information, or other authentication information. Further, in certain embodiments, the secure storage 117 can be used interchangeably with another memory.

The sensor module 207 may include biometric sensors and other sensors that provide a means to capture information, such as bar code readers. Biometric sensors such as fingerprint scanners, iris scanners, voice scanners (e.g., using a microphone) can capture biometric data and store it in a memory (e.g., the secure storage) of the UE 101. Then, the runtime module 205 may utilize the biometric data and compare it with stored local credentials. Images and/or audio can be captured using an image capture input device (e.g., a camera) or microphone associated with the sensor module 207. In one embodiment, visual media is captured in the form of an image or a series of images and sound is captured using discrete or continuous audio information. The sensor module 207 can be utilized by the runtime module 205 to capture audio or an image of the user or a portion of the user (e.g., a finger, palm, iris, face, etc.) for authentication. Moreover, the runtime module 205 can compare data points extracted from the images or voice audio to determine if the image/voice matches to a certain threshold level biometric or other data stored in the secure storage 117. In certain embodiments, the components of the sensor module 207 may be embedded in the UE 101 or may be an external addition to the UE 101. The sensor module 207 may be attached to the UE 101 using a network, such as a communication network or data network such as a bus (e.g., a universal serial bus (USB), a parallel bus, etc.).

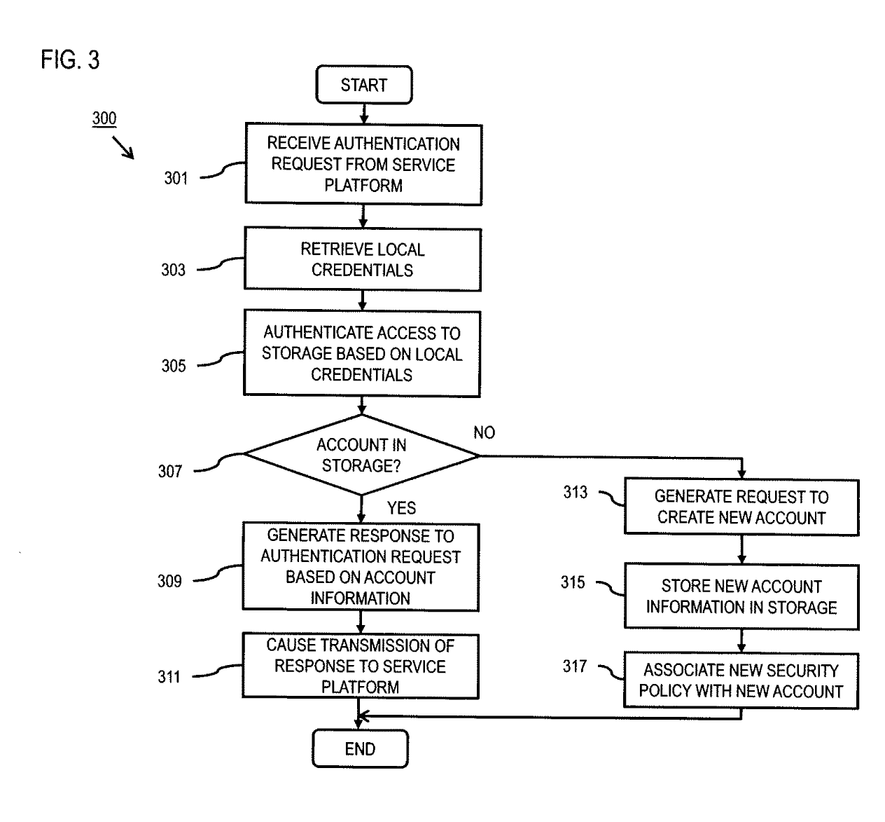

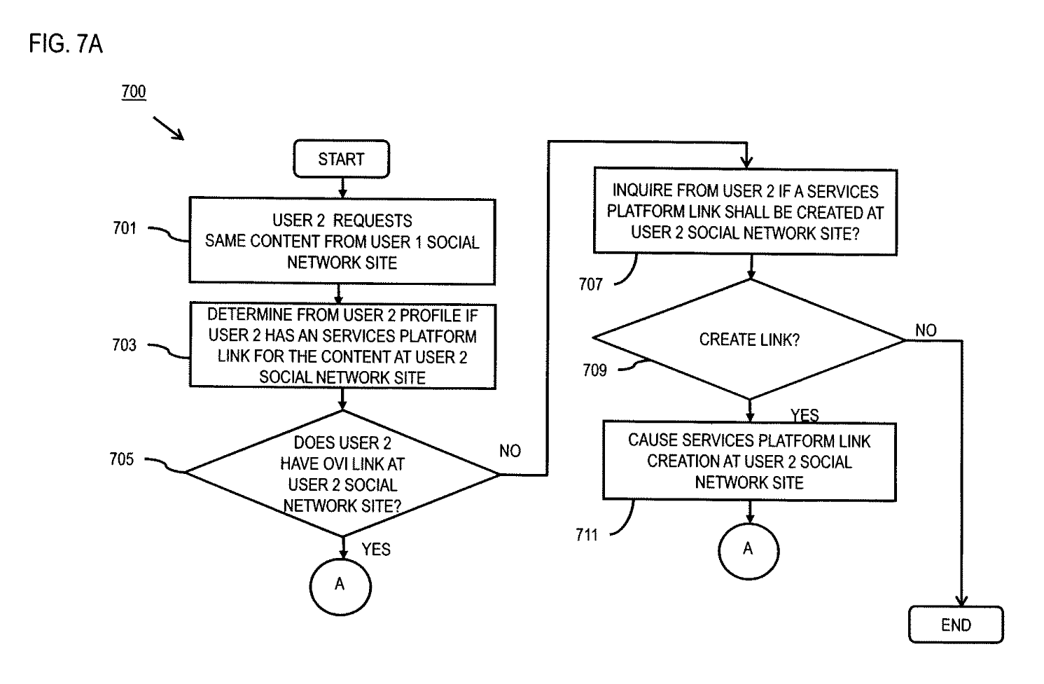

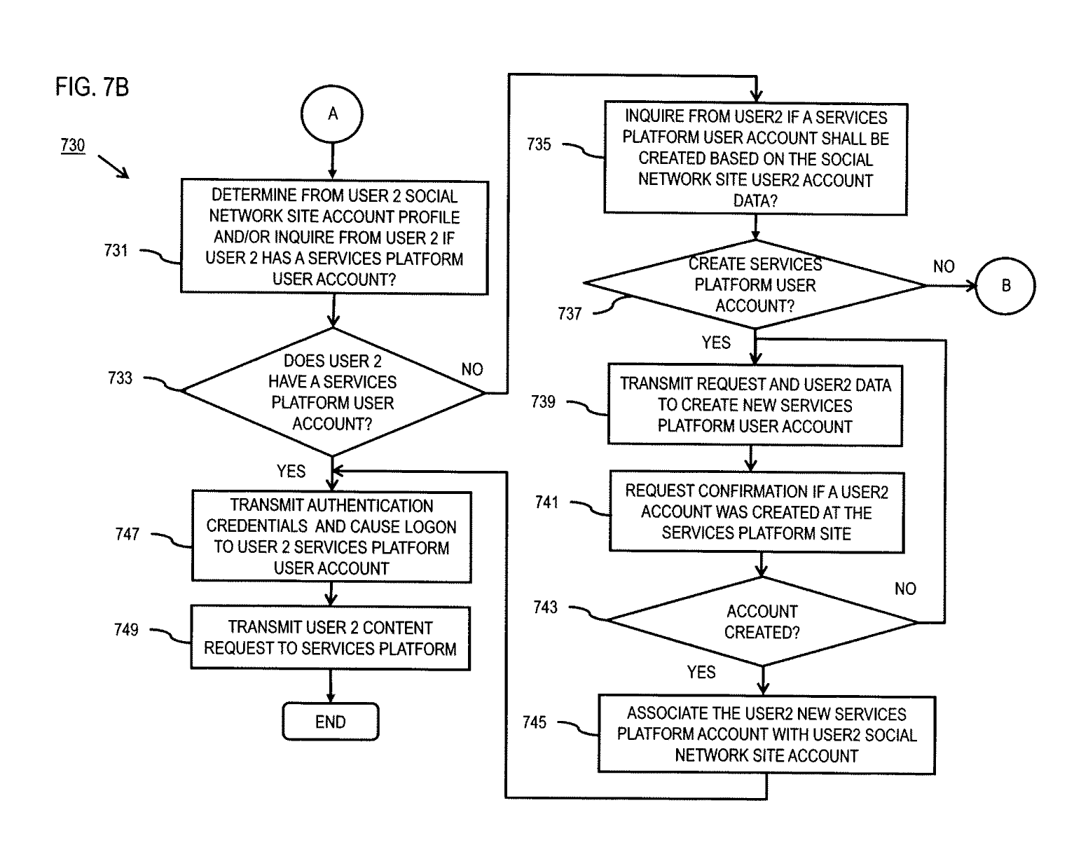

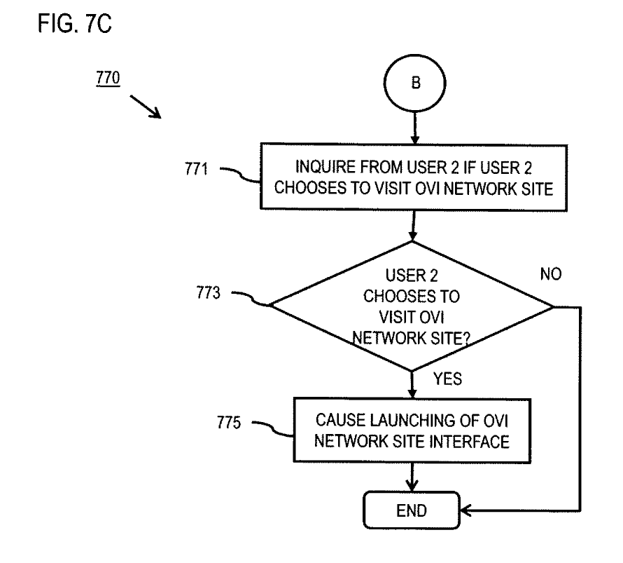

FIG. 3 is a flowchart of a process for authenticating with a remote platform using local credentials, according to one embodiment. In one embodiment, the trust module 115 and/or applications 107 (e.g., executing on the runtime module 205) performs the process 300 and is implemented in, for instance, a chip set including a processor and a memory as shown FIG. 7. As such, the trust module 115, applications 107, and/or runtime module 205 can provide means for accomplishing various parts of the process 300 as well as means for accomplishing other processes in conjunction with other components of the UE 101 and/or services platform 103. For simplicity, applications 107 of the UE 101 is used to describe the process 300, but it is noted that other processes or modules of the UE 101 can perform the process 300.

At step 301, the application 107 receives, at the UE 101, an authentication request from a services platform 103. This authentication request can be caused by an authentication module 109 of the services platform 103 in response to a request by the applications 107 for services and/or content. Further, this authentication request may be utilized to cause the process 300 to be initiated. As such, the services platform 103 causes, at least in part, the UE 101 to perform one or more steps of process 300. In one example, the applications 107 can request access to download music content from the services platform 103. The authentication request can be caused to determine whether the UE 101, user, or applications 107 should be granted access to the music content. Further, the authentication request can cause the applications 107 to locally authenticate with the user and send a response to the services platform 103 indicating whether the user should be granted the access.

Next, at step 303, the applications 107 retrieves local credentials to authenticate access to storage (e.g., the secure storage 117). In certain embodiments, to retrieve the local credentials, the applications 107 can cause, at least in part, actions that result in a lock state on the UE 101 upon receipt of the authentication request. The retrieving of the local credentials removes the lock state. If the local credentials are not entered within a certain predetermined time limit, the UE 101 can return to a state before the request was initiated and the applications 107 is not granted access to the requested services or content. As noted above, local credentials can include a PIN code, biometric credentials, other authentication, etc. In one example, the UE 101 provides limited access unless the local credentials are provided, a time limit expires, or the user escapes from the lock state. This lock state can include a presentation requesting the local credentials.

At step 305, the applications 107 authenticate the access to the secure storage 117 based, at least in part, on the local credentials. The applications 107 can receive the local credentials and compare the local credentials to local credentials stored in a memory of the UE 101 such as the secure storage 117. These local credentials can be updated by the user and/or set while activating the UE 101, the applications 107, etc. In certain embodiments, the trust module 115 is used to access the secure storage 117. As such, the trust module 115 is signed with permission to access the secure storage 117. In certain embodiments, for example, when the local credentials include biometric information, the applications 107 receives the biometric information, analyzes the biometric information, and compares the analysis (e.g., extrapolated points of a fingerprint) with the stored local credentials. If the local credentials match to a certain threshold the stored local credentials, the authentication is valid. In the case of a PIN code or username and password local credentials, if the local credentials match the stored local credentials, the authentication is valid. If the local credentials are valid, the applications 107 can have access to the secure storage 117 to generate a response to send the services platform 103. Further, a single set of local credentials can be used to provide access to more than one services platforms 103a-103n. As such, the authentication request can include an identifier (e.g., a URL) or other account information to indicate which services platform 103 the authentication request is associated with.

Next, at step 307, the application 107 determines that account information for the services platform 103 is included in the secure storage 117. The account information can include authentication credentials associated with the services platform 103, a security policy associated with the services platform 103, a means to determine authentication credentials for the services platform 103 (e.g., a key for a DRM associated with the services platform 103), or a combination thereof. Further, the account information can include one or more identifiers (e.g., URL, serial number, etc.) of the services platform 103 and/or services provided by the services platform 103. With this approach a data structure can be included in the secure storage that includes one or more identifiers of the services platform 103 (e.g., the URL, name, etc.), an account identifier associated with an account of the user (e.g., a phone number, serial number, username, etc.), a security policy for determining what information should be sent to the services platform 103 to verify that the user has access to the services and/or content of the services platform(s) 103. The applications 107 can determine that the account information for the services platform 103 is in the secure storage 117 by comparing an identifier from the services platform 103 with the services platforms 103 identified in the data structure(s).

If the account information is found, the applications 107 cause generation of a response to the authentication request based, at least in part, on the account information (step 309). The response can include account information that should be sent to the services platform 103 based on the security policy. In certain embodiments, the security policy is set in a manner such that different account information (e.g., authentication information associated with the user) can be sent to the services platform 103 based on a security level of the authentication request. As such, different account information can be sent to the services platform 103 based on the security policy. For example, the account information may include that the user has an account associated with the services platform 103, authentication information (e.g., a username and password) stored in the secure storage 117, a key that the applications 107 can utilize to generate authentication information to send to the services platform 103, or the like.

Further, the response can additionally be based on an authentication of the services platform 103. In this manner, the applications 107 can request that the services platform 103 provide authentication information (e.g., a signature, a key based authentication, etc.) that the services platform 103 can receive the authentication information. The applications 107 can then verify that the services platform 103 is a valid requester of the authentication information based on the authentication. Certain security policies may be set so that only services platforms 103 that can be verified receive certain account information. For example, the applications 107 can determine that the security policy allows including the authentication credentials in the response. The application 107 includes the authentication credentials in the response if the request of the services platform 103 can be verified to be authentic. As previously noted, these authentication credentials can be different from the local credentials. Then, at step 311, the application 107 causes, at least in part, transmission of the response to the services platform 103.

If, at step 307, the applications 107 determines that the account information for the services platform 103 is not in the secure storage 117, the applications 107 generates a request to the services platform 103 to create a new account (step 313). The request can include new account information including predetermined registration information and new authentication credentials. The predetermined registration information can be populated using information stored on a contact card or other storage of the UE 101. Next, at step 315, the applications 107 causes storage of the new account information in the secure storage 117. This information can be in the form of the data structure described above that can include one or more identifiers of the services platform 103 (e.g., the URL, name, etc.), an account identifier associated with an account of the user, a security policy for determining what information should be sent to the services platform 103 to verify that the user has access to the services and/or content of the services platform(s) 103. Further, the applications 107 associate a new security policy with the new account in the secure storage 117 (step 317). The new security policy for the new account can be received from the services platform 103 and/or be defined by the user.

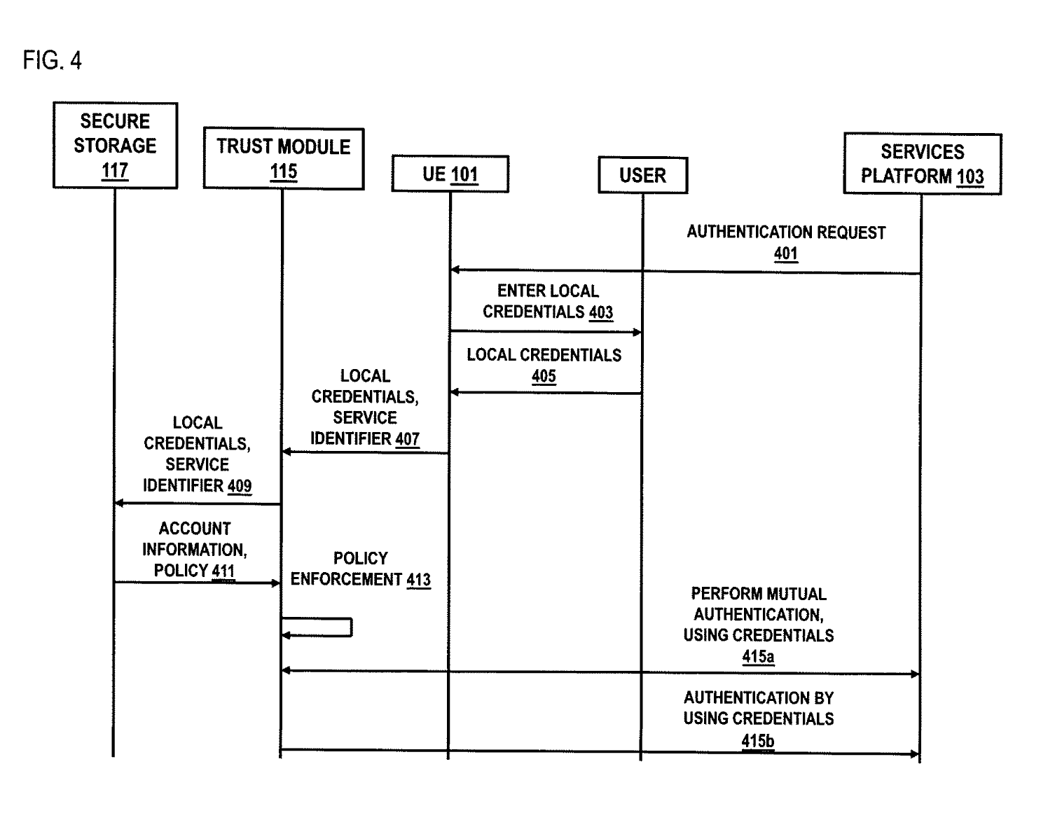

FIG. 4 is a ladder diagram of a process for authenticating with a remote platform using credentials local to a user device, according to one embodiment. A network process on the network is represented by endpoints of the vertical lines. A message passed from one process to another is represented by horizontal arrows. A step performed by a process is indicated by the text. At step 401, the UE 101 (e.g., via applications 107) receives an authentication request from a services platform 103. As noted above, the authentication request can be in response to a request for services by one or more applications 107 of the UE 101. The services platform 103 can optionally include one or more certificates or other information that may be used to authenticate the services platform's identity and/or to be used to generate a response to the authentication request.

Then, at step 403, the UE 101 requests a user to provide the UE 101 with local credentials. In certain embodiments, as noted above, the local credentials are credentials stored on the UE 101 that can be utilized to provide authentication for one or more services platforms 103 with one or more different authentication criteria. The local credentials can be a PIN code, biometric information, or the like. At step 405, the user enters the local credentials. In the case of biometric information, a sensor (e.g., a fingerprint sensor, a camera, etc.) can be used to enter the local credentials. In other cases, a touch screen input, keypad device, etc., can be used to enter the local credentials (e.g., a PIN code, local username and/or password, etc.).

The UE 101 sends the local credentials, a service identifier of the services platform 103 and/or a service of the services platform 103 to a trust module 115 of the UE 101 (step 407). The trust module 115 can be used to determine the authenticity of the communications from the services platform 103 (e.g., via processing an authentication certificate). In certain embodiments, the trust module 115 and the services platform 103 can be associated by a signature or other authentication mechanism to show a trust between the trust module 115 and the services platform 103. At step 409, the local credentials and service identifier (e.g., URL) are used to retrieve account information and/or a security policy from a secure storage 117. The security policy can be used to determine what account information to transmit to the services platform 103 for authenticating the user. Moreover, the security policy can be defined and/or modified by the user. For example, the user may change the security policy to only allow selected services platforms 103 to receive one or more types of credentials or particular credentials.

The security policy, at step 411, is sent to and received by the trust module 115. Then, at step 413, the trust module 115 enforces the security policy to generate a response to the authentication response. In one embodiment, the security policy is part of the account information for the service. As such, the enforcement of the security policy includes generating the response. The response can include information that verifies to the services platform 103 that the user is has been authenticated locally. By way of example, the response can be generated by using one or more certificates provided by the services platform 103 and/or a certificate or key associated with the account information to generate a coded response. In another example, the trust module 115 may be signed or have a coding mechanism associated with the services platform 103 to generate a coded response. Further, the coded response can include authentication information associated with the services platform 103 that is stored in the account information.

Moreover, in certain embodiments, one or more types of credentials (e.g., username and password, transport layer security authentication, key code, etc.) can be sent as part of the response. Additionally, in certain embodiments, the authentication and/or credentials sent to the services platform 103 are specific to the trust module 115 and/or other applications 107 of the UE 101 rather than the user.

At step 415, the response is transmitted to the services platform 103 as part of authenticating the user. The authentication can include the trust module 115 requesting credentials from the services platform 103 to verify that the services platform 103 is a legitimate services platform 103 (step 415a). If authenticated, the response is sent. In other embodiments, the response can be sent to the services platform 103 without mutual authentication (e.g., step 415b).

Further, the services platform 103 can facilitate access, which can include granting access rights, based on the causing, at least in part actions that result in sending to the UE 101 the authentication request. This authentication can thus cause the UE 101 to further retrieve local credentials and authenticate access locally. The described processes and arrangement advantageously, according to certain embodiments, provide for facilitating access, by the services platform 103, to at least one interface to allow access to a service via at least one network. For example, granting access can include making network resources (e.g., bandwidth) available to the UE 101. Further, granting access may include the services platform 103 providing a web page interface for the UE 101.

In certain scenarios, as noted previously, because local authentication is used, a simpler authentication mechanism may be used at the services platform 103. With this simpler authentication approach back-end processing at the services platform 103 can be reduced, which in turn saves computing resources and network bandwidth for supporting the processing. For example, because the local authentication occurs, the services platform 103 may trust that the response is authenticated based on a signature in the response and need not re-authenticate.

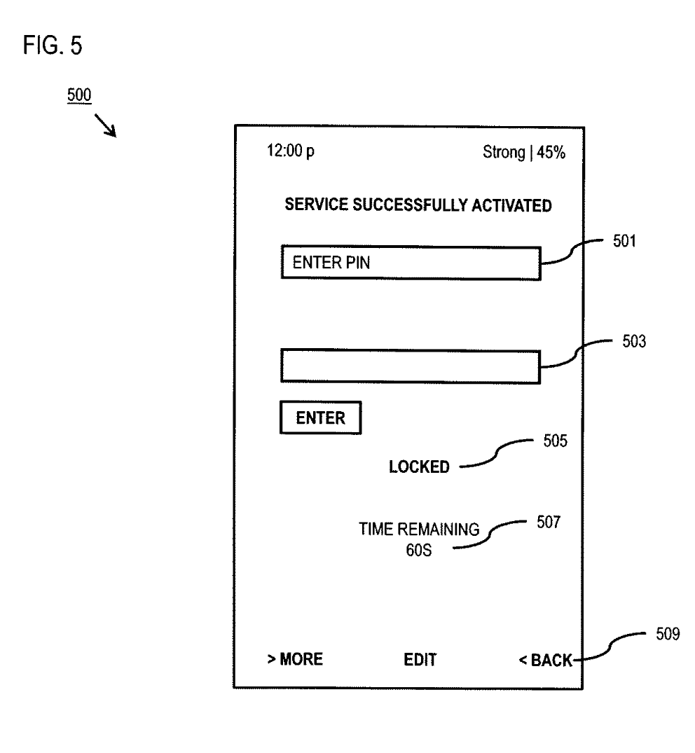

FIG. 5 is a diagram of a user interface utilized in the processes of FIG. 3, according to one embodiment. The user interface 500 shows a locked screen awaiting entry of local credentials by the user. In this example, the local credentials can be a PIN code. The PIN code request 501 can be presented on a portion of the screen. Further, a field 503 is provided for entry of the PIN code. The user interface 500 may limit access (e.g., lock 505 the screen) to the UE 101 while requesting the local credentials. As shown, the limited access can be overcome by entering the PIN code, waiting for a timeout 507, or escaping via a back field 509. If the local credentials are entered, the services from the services platform 103 requesting authentication can be provided after the UE 101 provides an authentication response to the services platform 103. Otherwise, if the back field 509 is activated or the timer 507 runs out, the services will not be provided to the UE 101. Further, additional security mechanisms may be utilized to prevent another user from attempting to fraudulently use services on the UE 101. For example, a timeout may be required between incorrect local credentials input.

With the above approaches, a user is able to securely receive services from services platforms 103 using local credentials. In this manner credentials to the services platform 103 are stored in a secure storage 117 on the UE 101. Local credentials can be used to access one or more credentials to services platforms 103. In this manner, the user of a UE 101 need not remember multiple complicated passwords to use the services on the user's UE 101. Further, with this approach, the processor time for authentication is reduced because the user may use a single authentication to acquire services from multiple services platforms 103.

The processes described herein for providing a single sign-on solution at a device may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

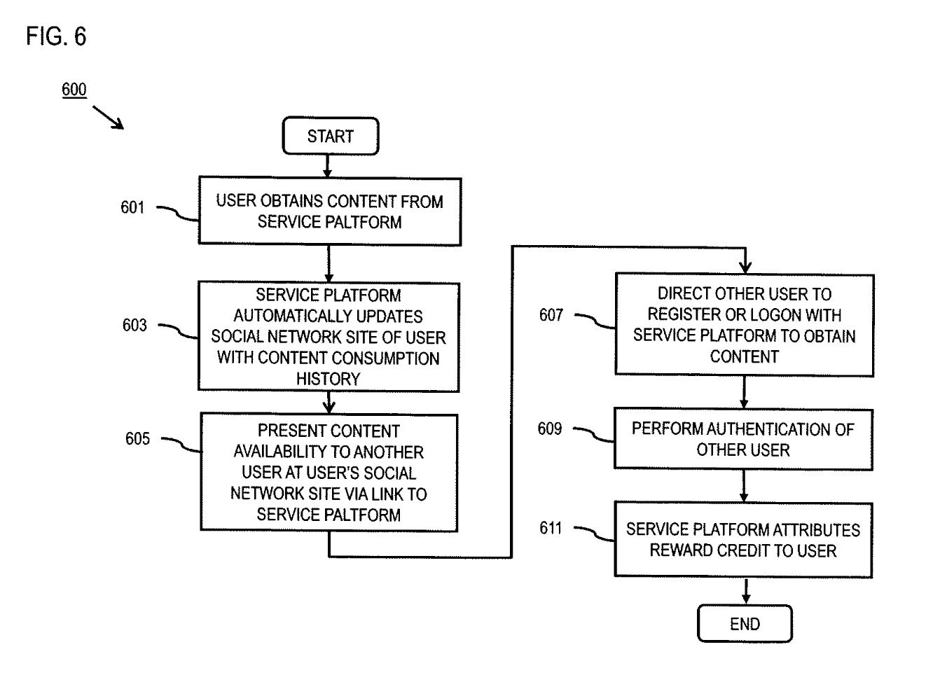

FIG. 6 is a flowchart of a process for interaction between a user, a services platform and one or more social network sites, according to one embodiment. In one embodiment, the trust module 115 and/or applications 107 (e.g., executing on the runtime module 205) performs the process 600 and is implemented in, for instance, a chip set including a processor and a memory as shown FIG. 18. As such, the trust module 115, applications 107, and/or runtime module 205 can provide means for accomplishing various parts of the process 600 as well as means for accomplishing other processes in conjunction with other components of the UE 101 and/or services platform 103. For simplicity, an application 107 of the UE 101 is used to describe the process 600, but it is noted that other processes or modules of the UE 101 can perform the process 600.

At step 601, UE 101 requests and receives content from the services platform 103. In one embodiment, the content can be one or more types of content available at the services platform 103 such as media services (e.g., music services, video services, photo services, etc.), navigation services, gaming services and/or the like. For example the content can be a music file.

At step 603, the services platform 103 updates user's one or more social network sites 121 with the recent content consumption history. In one embodiment, the social network sites 121 can include one or more sites such as Facebook®, MySpace® and/or the like. The update can be in the form of a message sent to the user's one or more social network site and the message can cause, at least in part, creation of an internet link in the form of text, picture, figure and/or the like.

At step 605, the content is made available to other users who wish to obtain the same content. In one embodiment, the other user visits the user's social network site and views the content consumption history. The other user chooses to obtain the same content and activates the link by selecting and/or clicking on the link, which causes, at least in part, creation of same link at other user's own social network site. For example, the link is for a music file downloaded from services platform 103. Upon activating the link to the services platform 103, a similar and/or same link is created at other user's own social network site.

At step 607, the activated link of 605, at least in part, determines whether the other user has an account on platform 103. In one embodiment, the other user has a user account and is logged onto the account. In another embodiment, the other user does not have a user account and the process causes, at least in part, creation of a new user account.

At step 609, the process responds to authentication request from the services platform 103. In one embodiment, the other user's social network site user account data is provided to the services platform 103 for authentication. In another embodiment, the other user's authentication credentials are provided to the services platform 103 for authentication.

At step 611, the services platform 103 attributes reward to the user's account for promoting the consumed content at user's social network sites 121. In one embodiment, a reward is attributed to the user's services platform 103 account. In another embodiment, the services platform 103 attributes the reward to the user's social network sites 121 account.

FIGS. 7A-7C are flowcharts of processes for content delivery to one or more users and updating a services platform and one or more social network sites, according to one embodiment. The processes can be performed by a combination of one or more services platform, social network sites and user equipment. The processes show steps for requesting content, delivering content, updating one or more user accounts with content consumption history information, tracking and rewarding one or more users for promoting the content at one or more social network sites.

FIG. 7A is a flowchart of process 700 for a visiting user at a social network site 121 to initiate a request for content available at services platform 103.

At step 701, visiting user causes a request for content to initiate from a user's social network site 121. In one embodiment, visiting user selects and/or activates a link for content at the user's social network site 121. For example, the link can be to one or more consumed contents at services platform 103 being promoted by the user.

At step 703, determination is made whether visiting user has a link to the services platform 103 which is providing the content at the visiting user's social network site 121. In one embodiment, visiting user does not have a link to the services platform 103.

At step 705, if the visiting user does not have a link, the process proceeds to 707; otherwise, the process proceeds to 731 of process 730 in FIG. 7B.

At step 707, the visiting user is inquired if a link to the services platform 103 shall be created at visiting user's social network site 121. In one embodiment, the visiting user does not have a link to the services platform 103 and selects to create a link at the visiting user's social network site 121. For example, visiting user is at user's social network site 121 and is inquired if a link to the services platform 103 shall be created.

At step 709, if visiting user selects the option to create a link to the services platform 103, a link to the services platform 103 is created at visiting user's social network site 121. For example, visiting user is at user's social network site Facebook® and selects to create a link to services platform OVI® at the visiting user's Facebook® site. The process, further proceeds to 731 of process 730 in FIG. 7B.

FIG. 7B is a flowchart of process 730 for determining whether the visiting user at a social network site 121 has a user account at services platform 103 and for causing creation of such account.

At step 731, a determination is made whether the visiting user has an account at services platform 103. In one embodiment, the determination is made by examining the visiting user's social network site 121 account. For example, the visiting user's social network site account profile indicates information on the visiting user's one or more services platform 103 accounts. In another embodiment, the visiting user is inquired to indicate whether visiting user has an account at one or more services platform 103.

At step 733, if the visiting user has an account at one or more services platform 103, then the process proceeds to step 747; otherwise, the process proceeds to step 735.

At step 747, the visiting user authentication credentials are transmitted and the visiting user is caused to logon to the visiting user's account at the services platform 103. In one embodiment, the social network site 121 causes automatic logon to the visiting user's account at the services platform 103 by providing visiting user's authentication credentials. For example, visiting user's account at social network site Facebook® provides the visiting user's authentication credentials to the visiting user's account at services platform OVI®.

At step 749, the visiting user's account at social network site 121 transmits to the services platform 103 the visiting user's request for content consumed and/or promoted by the user. For example, the visiting user's account at social network site Facebook® transmits to the services platform OVI® the visiting user's request for content consumed and/or promoted by the user and after completing step 737, the process ends.

However, if at step 733 it was determined that the visiting user does not have a user account at services platform 103, the process proceeds to step 735 where the visiting user is inquired whether a user account, for the visiting user, shall be created at services platform 103 based on visiting user's account data at the social network site 121.

At step 737, if the visiting user selects to create a user account at the services platform 103, then the process proceeds to step 743; otherwise, the process proceeds to step 771 of process 770 in FIG. 7C. In one embodiment, the visiting user selects to create a user account at the social network site 121. For example, the visiting user selects to create a user account at the services platform OVI® by using visiting user's account data at the social network site Facebook®.

At step 739, a request for creating a new visiting user account, including visiting user account data at social network sites 121, is transmitted to services platform 103. In one embodiment, a request for creating a new visiting user account and the visiting user account data at social network 121 site is transmitted to services platform 103. In another embodiment, the visiting user provides, at least in part, required visiting user data for creating a new account at the services platform 103.

At step 741, the social network site 121 requests confirmation of the visiting user account creation at the services platform 103. In one embodiment, the social network site 121 requests the confirmation from the services platform 103. In another embodiment, the visiting user requests the confirmation from the services platform 103. At step 743, if the requested account was created, the process proceeds to step 745; otherwise, the process returns to step 739.

At step 745, the visiting user's new services platform 103 account is associated with visiting user's social network site 121 account. In one embodiment, the visiting user's new services platform 103 account is associated with one or more social network sites. Upon completion of step 745, the process proceeds to steps 747 and 749, which have been described above.

FIG. 7C is a flowchart of process 770 for determining whether the visiting user at a social network site 121 selects to visit a services platform 103 without having and/or creating a user account at the services platform 103.

At step 737 of process 730 at FIG. 7B, visiting user had selected not to create a new user account at the services platform 103. At step 771, the visiting user is inquired if the visiting user chooses to visit the services platform 103. In one embodiment, the visiting user chooses to visit the services platform site without and/or before creating a new user account.

At step 773, if the visiting user chose to visit the services platform 103, the process proceeds to 775; otherwise, the process ends.

At step 775, the social network site 121 causes the visiting user access to the services platform 103. In one embodiment, the applications 107 presents a user interface application whereby the services platform 103 can be interacted with. For example, the visiting user UE 101 will have access to the services platform 103 internet site.

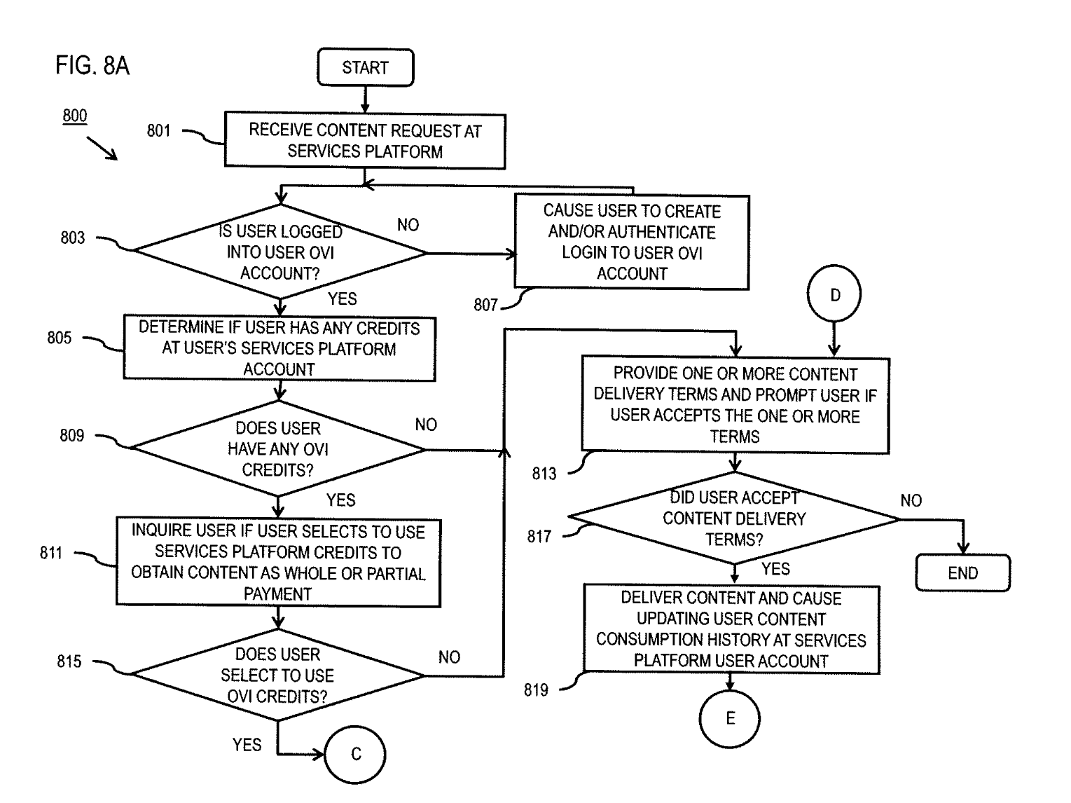

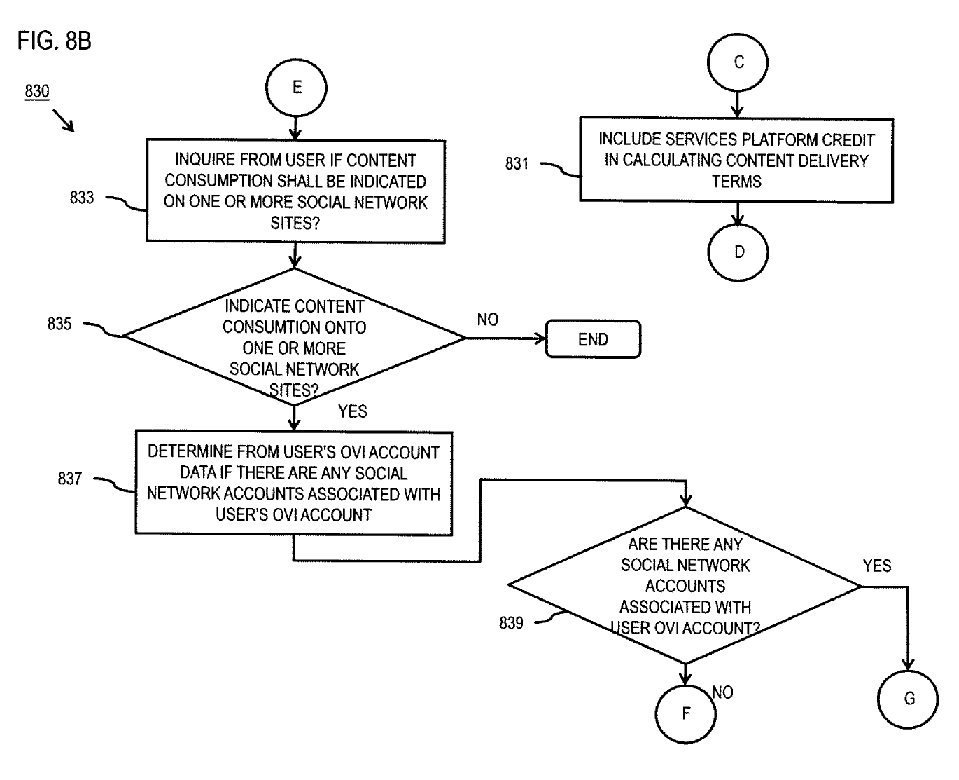

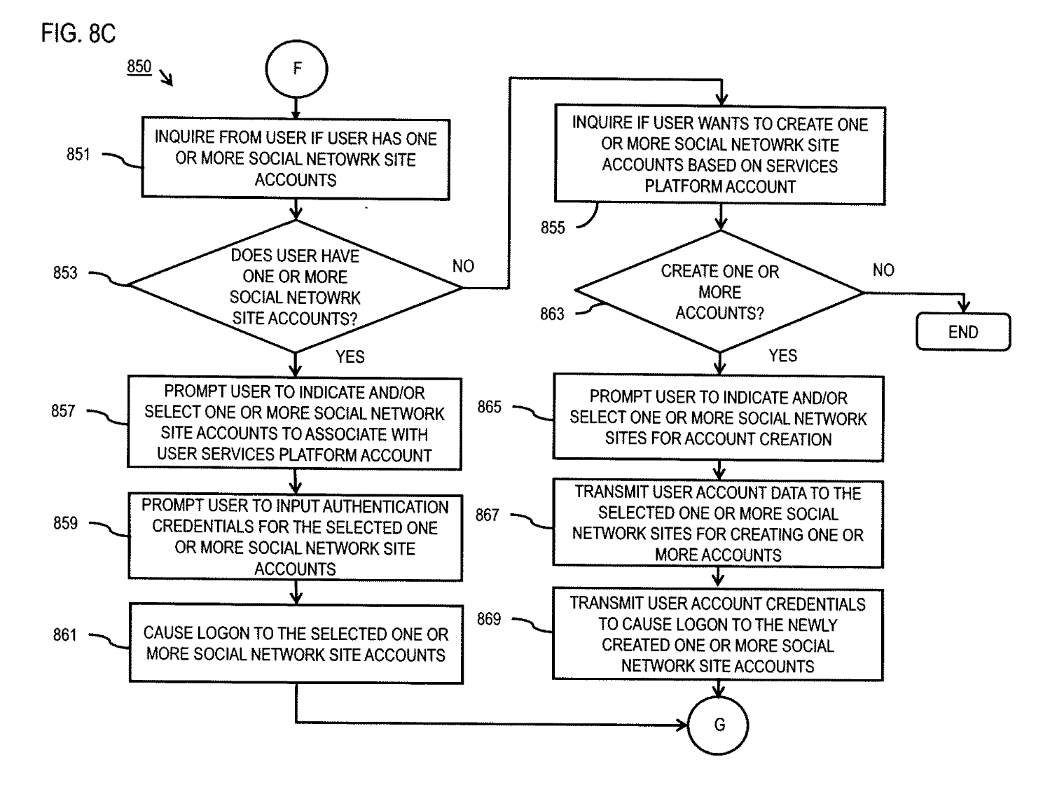

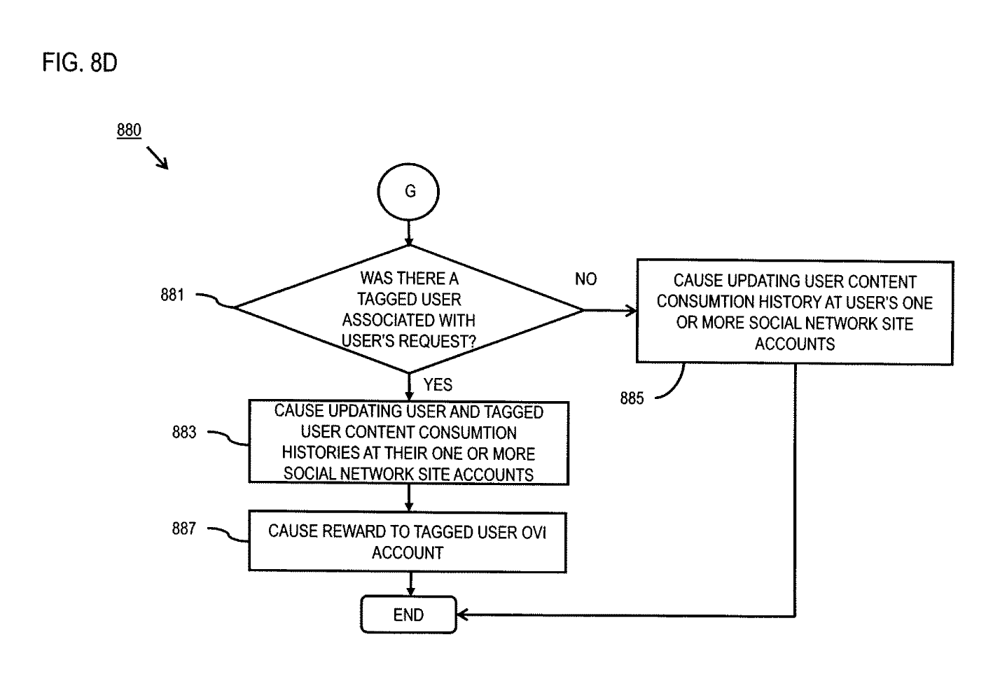

FIGS. 8A-8D are flowcharts of processes for content delivery to one or more users and updating a services platform and one or more social network sites, according to one embodiment. The processes can be performed by a combination of one or more services platform, one or more social network sites and one or more user equipment. The processes show steps for receiving one or more requests for content, delivering content, updating one or more user accounts with content consumption history information, tracking and rewarding one or more users for promoting the content at one or more user social network sites.

FIG. 8A is a flow chart of process 800 for the services platform 103 to receive a content request, prompt a user to make selections, deliver content and cause updating of the user account at one or more social network sites 121.

At step 801, the services platform 103 receives a request for content. In one embodiment, the request is from the UE 101 communicating with the services platform 103. In another embodiment, the request is from a user account at a social network site 121.

At step 803, the services platform 103 determines whether the user is logged on at a user account at the services platform 103. In one embodiment, the services platform 103 examines communication session information to determine if the user is logged on to the user's account at the services platform 103. If the user is logged on to the user's account, the process proceeds to step 805; otherwise, the process proceeds to step 807.

At step 807, the user is prompted to either create a services platform 103 user account and logon or if the user has a services platform 103 user account, to logon to the user's account. In one embodiment the user creates a new user account at services platform 103 and then logs on to the account. In another embodiment, the user has a services platform 103 user account and logs on to the account.

At step 805, a determination is made whether the user has any credits in the user account at the services platform 103. In one embodiment, the user has some credit in the user account at the services platform 103. For example the credit is a reward credited to the user account. In another embodiment, the requested content is available free of charge; if so, the content can be delivered without checking user's account for any reward credits or without inquiring about a payment. For example, if the content is available free of charge, upon acceptance of terms of use and/or terms of delivery, the content is delivered to UE 101.

At step 809, if the user has some credits in the user account at the services platform 103, the process proceeds to step 811; otherwise, the process proceeds to step 813.

At step 811, user is inquired whether the user selects to use available credits from the user account at services platform 103.

At step 815, if the user selects to use credits from user account at services platform, the process proceeds to step 831 at process 830 of FIG. 8B; otherwise, the process proceeds to step 813.

At step 813, services platform 103 provides one or more content delivery terms and prompts the user to select either one of accept or reject options.

At step 817, if the user selects the reject option, the process ends; otherwise, the process proceeds to step 819.

At step 819, the services platform 103 causes delivery of the requested content to the UE 101 and the user's services platform content consumption history is updated to include the delivered one or more contents and the process proceeds to step 833 at process 830 of FIG. 8B.

FIG. 8B is a flow chart of process 830 for a services platform 103 to track content consumption, track reward at the services platform 103 user account, prompt a user to make selections, cause updating of user account at one or more social network sites 121.

At step 833, user is inquired whether content consumption history information shall be indicated at one or more social network site 121 user accounts.

At step 835, if the user selects that there is to be no indication, the process ends; otherwise, the process proceeds to step 837.

At step 837, services platform 103 determines if there are one or more social network site 121 accounts associated with the user's account at services platform 103.

At step 839, if there are one or more social network sites 121 associated with the user account at the services platform 103, the process proceeds to step 881 of process 880 at FIG. 8D; otherwise, the process proceeds to step 851 of process 850 at FIG. 8C.

FIG. 8C is a flow chart of process 850 for a services platform 103 to determine whether a user at services platform 103 has one or more social network site 121 accounts. If the user does not have any social network site 121 accounts, the user is given an opportunity to create one or more social network site 121 user accounts. However, if the user has one or more social network site 121 user accounts, the user is given an opportunity to logon to one or more social network site 121 user accounts.

At step 851, services platform 103 inquires whether the user has one or more social network sites 121 user accounts. At step 853, if the user has one or more social network sites 121 accounts, the process proceeds to step 857; otherwise the process proceeds to step 855.

At 857, the user is prompted to indicate and/or select one or more social network sites 121 to associate with user account at services platform 103. At step 859, the user is prompted to input authentication credentials for the selected one or more social network sites 121 accounts.

At step 861, the services platform 103 causes logon to the selected one or more social network sites 121 accounts and the process proceeds to step 881 of process 880 at FIG. 8D.

However, at step 853 if the user indicated that there are no user accounts at any social network sites 121, then the process at 855, inquires if user selects to create one or more social network sites 121 accounts based on the user account data at the services platform 103.

At step 863, if one or more use accounts are to be created at one or more social network sites 121, the process proceeds to 865; otherwise, the process ends. At step 865, the user is prompted to indicate and/or select one or more social network sites 121 where one or more user accounts will be created.

At step 867, the services platform 103 transmits one or more requests including, at least in part, user account data to one or more social network sites 121 for creating one or more accounts. At step 869, the services platform 103 transmits logon request including, at least in part, user account credentials to one or more social network sites 121 for logging on to the one or more accounts and the process proceeds to 881 of process 880 at FIG. 8D.

FIG. 8D is a flow chart of process 880 for a services platform 103 to determine if a user should be rewarded for promoting content consumed by another user. If a request for content was caused by a visiting user visiting another user's social network site 121, then the user's account is rewarded credit at services platform 103.

At step 881, a determination is made whether the user request for content from services platform 103 resulted from the user requesting the content from another user's social network sites 121. In one embodiment, the request was caused by a visiting user visiting another user's social network sites 121 account where the user information will be tagged and included in the visiting user's request for content. For example, a tagged user is a user who has consumes content from a services platform 103 and then promotes the content at the user's one or more social network site 121 accounts where the same content is presented to visiting users. In another embodiment, a tagged user is a user who is promoting the content at the tagged user's social network sites 121 where one or more visiting users can initiate one or more requests for the content. If there is information about a tagged user, the process proceeds to 883; otherwise, the process proceeds to 885.

At step 883, the services platform 103 causes updating of content consumption history information of the user's and the tagged user's one or more social network site 121 accounts. In one embodiment, the content consumption history information of the user and the tagged user at one or more social network sites 121 are updated.

At step 887, the services platform 103 attributes reward to the tagged user's services platform 103 account. In one embodiment, the reward is attributed to tagged user's social network sites 121 account selected by the tagged user. In another embodiment, the reward is attributed to another user's services platform 103 account selected by the tagged user. For example, the tagged user can assign/gift the reward to an account other than the tagged user's account such as a friend's account, a relative's account and/or the like.

At step 885, the services platform 103 causes updating of user's one or more social network sites 121 accounts content consumption history information indicating user's content consumption. In one embodiment, user's content consumption history information at one or more social network sites 121 is updated. In another embodiment, the user is prompted to select one or more social network site 121 accounts to update user's content consumption history information. In another embodiment, the user does not select any social network sites 121.

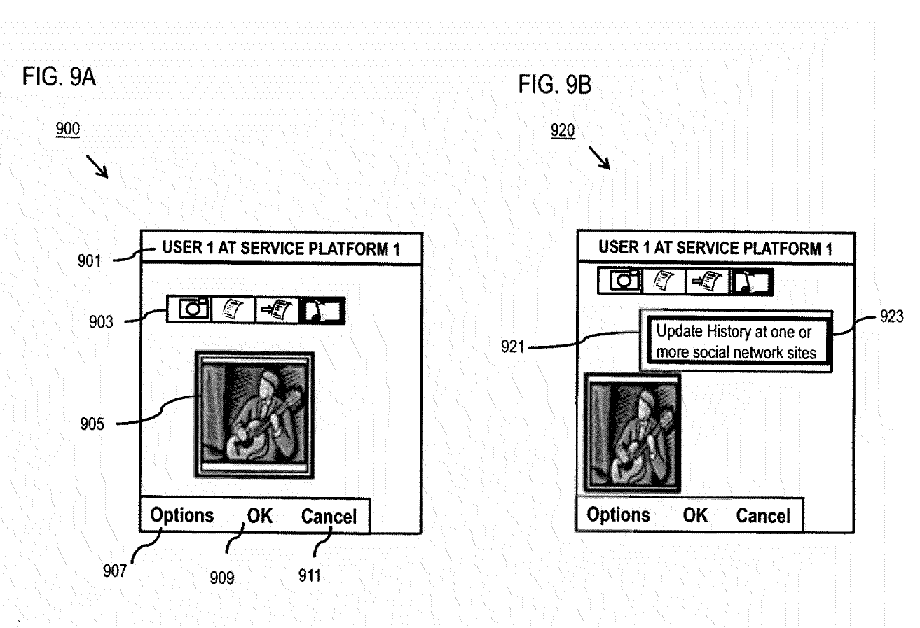

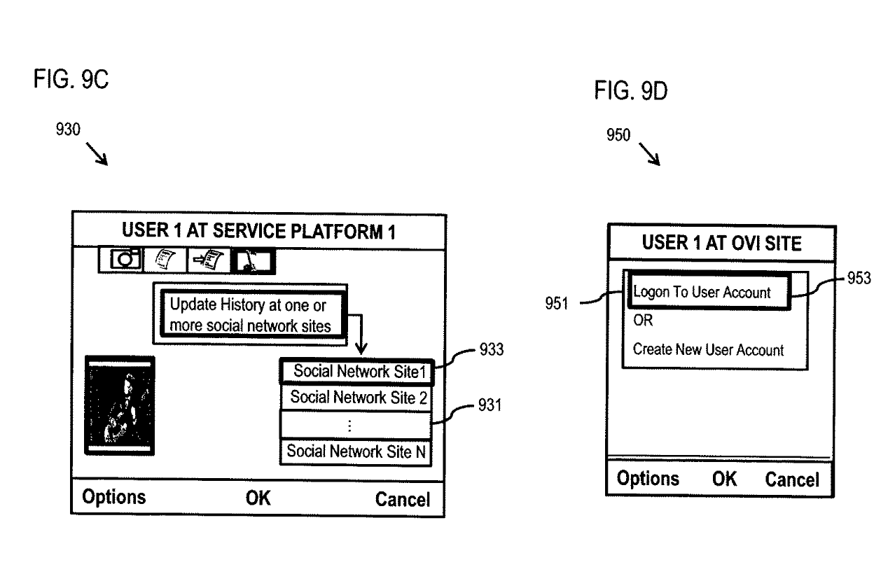

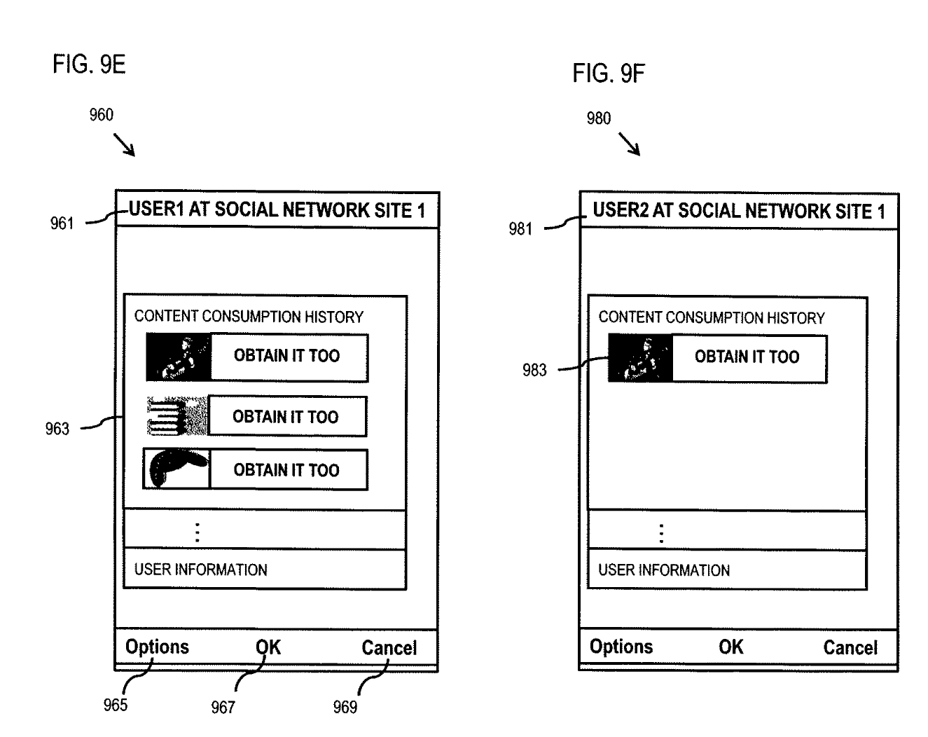

FIGS. 9A-9F are diagrams of a user interface utilized in the processes of FIG. 6, according to one embodiment. These user interfaces can receive inputs (e.g., via a touch screen input and/or keypad) from a user of UE 101.

FIG. 9A is a diagram of a user interface 900 that can receive input marking a content item selected by a user of UE 101. Tile window 901 shows the user and the network site currently active. In one embodiment, user is at services platform. For example user is at services platform OVI®. The selection panel 903 shows types of content available at the services platform 103. For example, content is media services, (such as music services, video services, photo service, book services, etc), navigation services, gaming services, textual content and/or the like. The selected panel 905 indicates selected content. For example the content is a musical album. Options button 907 may be selected to display a window of options that can be selected. The OK button 909 may be selected to go forward with a selected option. The Cancel button 911 may be selected to cancel a selected option.

FIG. 9B is a diagram of a user interface 920 for selecting a further action on consumed content. A further selection panel 921 shows an option for updating content consumption history at one or more social network sites 121. Selection highlight 923 shows the user selecting the option to update content consumption history at one or more user social network sites 121. For example, user downloads content from OVI® and selects to update user's content consumption history information at user's Facebook® account.

FIG. 9C is a diagram of a user interface 930 for selecting one or more social network sites 121. Selection panel 931 presents to the user with one or more social network sites 121 for selection. In one embodiment, the one or more social network sites 121 are predefined. In another embodiment, an option is presented to further indicate and/or add one or more social network sites 121.

FIG. 9D is a diagram of a user interface 950 for selecting an action for accessing one or more social network sites 121 user accounts. Selection panel 951 presents to the user one or more choices for accessing and/or creating a user account. Selection highlight 953 shows a user selection to logon to user account. In one embodiment, the user has an account at one or more social network sites 121 and selects to logon to one or more social network sites 121 user accounts. In another embodiment, the user selects to create one or more new user accounts at one or more social network sites 121.

FIG. 9E is a diagram of a user interface 960 showing a user account window at a social network site 121. Title window 961 shows the user and the social network site currently active. For example, user is at social network site 1. The informative panel 963 shows user information such as content consumption history information, user information and/or the like. The informative panel can be customized by the user to display a variety of information. In one embodiment, the content consumption history information shows information on content consumed by the user. For example, the information is on one or more consumed music albums, books, games and/or the like. Further, consumed contents can be illustrated as links in the form of text, a figure, a picture, a symbol and/or the like. Each link can have a selection button to cause an action such as launch a new interactive user interface panel, display further information about the selected content item and/or present options to obtain same content item. In one embodiment, the user's social network site 121 is visible to and available for interaction with one or more other visiting users at the social network site 121. In another embodiment, a visiting user selects a content item in 963 causing execution of process 700 of FIG. 7A. Options button 965 may be selected to display a window of options that can be selected. The OK button 967 may be selected to go forward with a selected option. The Cancel button 969 may be selected to cancel a selected option.

FIG. 9F is a diagram of a user interface 980 showing interaction at a social network sites 121 with a visiting user. Title window 981 shows the user and the network site currently active. For example, visiting user is at social network site 1. Link indicator 983 shows the content the visiting user has selected to obtain from the user's social network sites 121. In one embodiment, visiting user social network sites 121 has a link 983 to content item in 963 causing, at least in part, execution of process 700 of FIG. 7A.

The processes described herein for providing authentication and promoting content may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

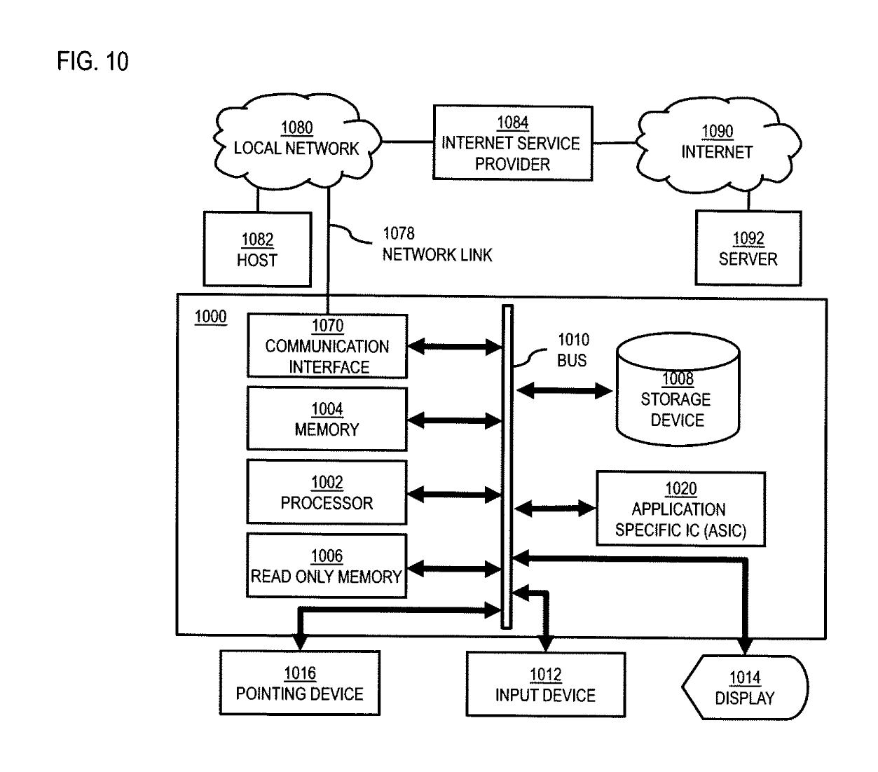

FIG. 10 illustrates a computer system 1000 upon which an embodiment of the invention may be implemented. Although computer system 1000 is depicted with respect to a particular device or equipment, it is contemplated that other devices or equipment (e.g., network elements, servers, etc.) within FIG. 10 can deploy the illustrated hardware and components of system 1000. Computer system 1000 is programmed (e.g., via computer program code or instructions) to provide a single sign-on solution at a device as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps of providing a single sign-on solution at a device.

A bus 1010 includes one or more parallel conductors of information so that information is transferred quickly among devices coupled to the bus 1010. One or more processors 1002 for processing information are coupled with the bus 1010.

A processor (or multiple processors) 1002 performs a set of operations on information as specified by computer program code related to providing a single sign-on solution at a device. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1000 also includes a memory 1004 coupled to bus 1010. The memory 1004, such as a random access memory (RAM) or other dynamic storage device, stores information including processor instructions for providing a single sign-on solution at a device. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for providing a single sign-on solution at a device, is provided to the bus 1010 for use by the processor from an external input device 1012, such as a keyboard containing alphanumeric keys operated by a human user, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT) or a liquid crystal display (LCD), or plasma screen or printer for presenting text or images, and a pointing device 1016, such as a mouse or a trackball or cursor direction keys, or motion sensor, for controlling a position of a small cursor image presented on the display 1014 and issuing commands associated with graphical elements presented on the display 1014. In some embodiments, for example, in embodiments in which the computer system 1000 performs all functions automatically without human input, one or more of external input device 1012, display device 1014 and pointing device 1016 is omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of application specific ICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 105 for the UE 101.

The term “computer-readable medium” as used herein refers to any medium that participates in providing information to processor 1002, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1008. Volatile media include, for example, dynamic memory 1004. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1020.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system 1000 can be deployed in various configurations within other computer systems, e.g., host 1082 and server 1092.

At least some embodiments of the invention are related to the use of computer system 1000 for implementing some or all of the techniques described herein. According to one embodiment of the invention, those techniques are performed by computer system 1000 in response to processor 1002 executing one or more sequences of one or more processor instructions contained in memory 1004. Such instructions, also called computer instructions, software and program code, may be read into memory 1004 from another computer-readable medium such as storage device 1008 or network link 1078. Execution of the sequences of instructions contained in memory 1004 causes processor 1002 to perform one or more of the method steps described herein. In alternative embodiments, hardware, such as ASIC 1020, may be used in place of or in combination with software to implement the invention. Thus, embodiments of the invention are not limited to any specific combination of hardware and software, unless otherwise explicitly stated herein.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server host 1092 transmits program code for a particular application, requested by a message sent from computer 1000, through Internet 1090, ISP equipment 1084, local network 1080 and communications interface 1070. The received code may be executed by processor 1002 as it is received, or may be stored in memory 1004 or in storage device 1008 or other non-volatile storage for later execution, or both. In this manner, computer system 1000 may obtain application program code in the form of signals on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

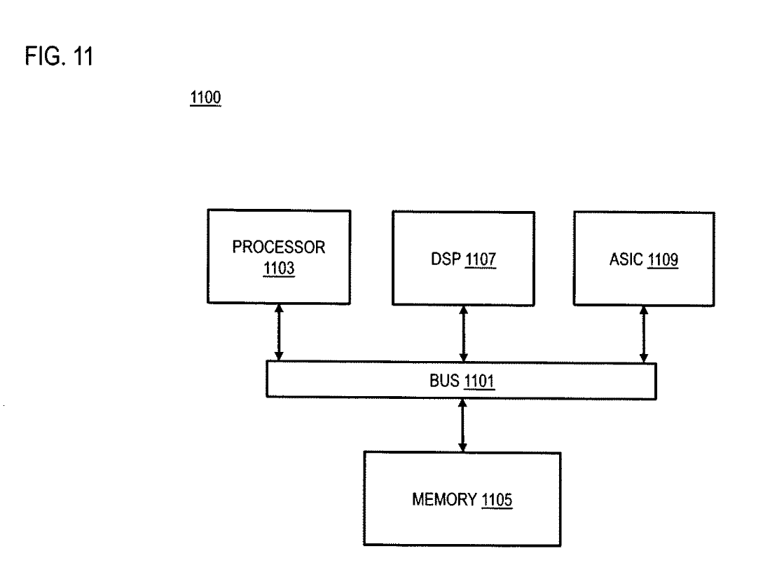

FIG. 11 illustrates a chip set or chip 1100 upon which an embodiment of the invention may be implemented. Chip set 1100 is programmed to provide a single sign-on solution at a device as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of providing user interface navigation information associated with the availability of services. Chip set or chip 1100, or a portion thereof, constitutes a means for performing one or more steps of providing a single sign-on solution at a device.

In one embodiment, the chip set or chip 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to provide a single sign-on solution at a device. The memory 1105 also stores the data associated with or generated by the execution of the inventive steps.

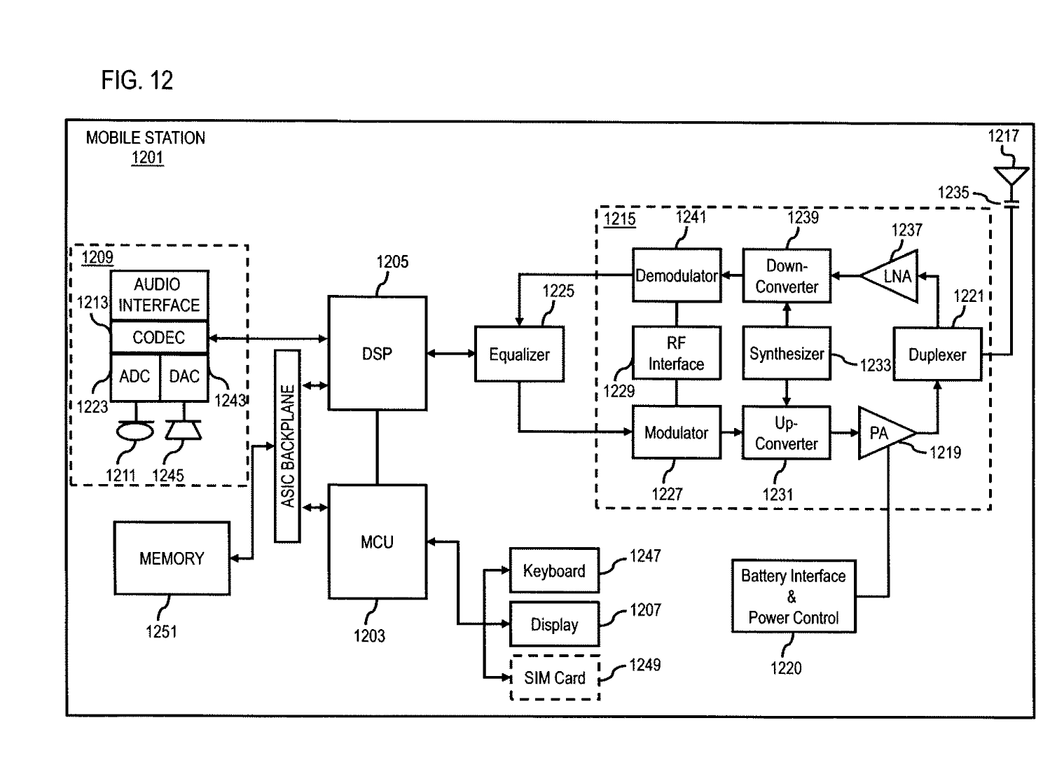

FIG. 12 is a diagram of exemplary components of a mobile terminal (e.g., handset) for communications, which is capable of operating in the system of FIG. 1, according to one embodiment. In some embodiments, mobile terminal 1200, or a portion thereof, constitutes a means for performing one or more steps of providing a single sign-on solution at a device. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps of providing a single sign-on solution at a device. The display 1207 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203—which can be implemented as a Central Processing Unit (CPU) (not shown).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile terminal 1201 to provide a single sign-on solution at a device. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
receiving an authentication request from a services platform;
retrieving local credentials to authenticate access to a storage;
authenticating the access to the storage based, at least in part, on the local credentials;
if authenticated, determining that account information for the services platform is in the storage, the account information including authentication credentials associated with the services platform, a security policy associated with the services platform, or a combination thereof; and
generating a response to the authentication request based, at least in part, on the account information.

2. A method of claim 1, wherein the generating of the response is further based on authenticating the services platform.

3. A method of claim 1, further comprising:
determining that the security policy allows including the authentication credentials in the response;
including the authentication credentials in the response; and
causing, at least in part, transmission of the response to the services platform.

4. A method of claim 1, further comprising:
causing, at least in part, actions that result in a lock state on the device on receipt of the authentication request,
wherein the retrieving of the local credentials removes the lock state.

5. A method of claim 1, further comprising:
determining that the account information for the services platform is not in the storage;
generating a request to the services platform to create a new account, the request including new account information including predetermined registration information and new authentication credentials; and
storing the new account information in the storage.

6. A method of claim 5, further comprising:
receiving a new security policy for the new account; and
associating the new security policy with the new account in the storage.

7. A method of claim 1, wherein the local credentials include a personal identity code, a biometric input, or a combination thereof.

8. A method of claim 1, wherein the storage is a secure storage with access limited to signed applications or processes.

9. An apparatus comprising:
at least one processor; and
at least one memory including computer program code,
the at least one memory and the computer program code configured to, with the at least one processor, cause the apparatus to perform at least the following,
receive an authentication request from a services platform;
retrieve local credentials to authenticate access to a storage;
authenticate the access to the storage based, at least in part, on the local credentials;
if authenticated, determine that account information for the services platform is in the storage, the account information including authentication credentials associated with the services platform, a security policy associated with the services platform, or a combination thereof; and
generate a response to the authentication request based, at least in part, on the account information.

10. An apparatus of claim 9, wherein the generating of the response is further based on authenticating the services platform.

11. An apparatus of claim 9, wherein the apparatus is further caused, at least in part, to:
determine that the security policy allows including the authentication credentials in the response;
include the authentication credentials in the response; and
cause, at least in part, transmission of the response to the services platform.

12. An apparatus of claim 9, wherein the apparatus is further caused, at least in part, to:
cause, at least in part, actions that result in a lock state on the apparatus on receipt of the authentication request,
wherein the retrieving of the local credentials removes the lock state.

13. An apparatus of claim 9, wherein the apparatus is further caused, at least in part, to:
determine that the account information for the services platform is not in the storage;
generate a request to the services platform to create a new account, the request including new account information including predetermined registration information and new authentication credentials; and
store the new account information in the storage.

14. An apparatus of claim 13, wherein the apparatus is further caused, at least in part, to:
receive a new security policy for the new account; and
associate the new security policy with the new account in the storage.

15. An apparatus of claim 9, wherein the local credentials include a personal identity code, a biometric input, or a combination thereof.

16. An apparatus of claim 9, wherein the storage is a secure storage with access limited to signed applications or processes.

17. An apparatus of claim 9, wherein the apparatus is further caused, at least in part, to:
cause, at least in part, update of user content consumption history information for one or more users at respectively one or more social network site user accounts; and
cause, at least in part, promotion of the content to one or more visiting users at one or more social network sites.

18. An apparatus of claim 17, wherein the apparatus is further caused, at least in part, to:
determine that a content request has, at least in part, originated from the visiting user's social network site account; and
attribute reward credit to the account of the user in response to the content consumption by the visiting user.

19. An apparatus of claim 17, wherein the apparatus is further caused, at least in part, to:
cause, at least in part, substantially automated user account creation at a services platform using user social network sites account profile data; or
cause, at least in part, substantially automated logon to the services platform using user social network sites account authentication credentials.

20. An apparatus of claim 17, wherein the apparatus is further caused, at least in part, to:
cause, at least in part, substantially automated user account creation at one or more social network sites using user services platform account profile data; or
cause, at least in part, substantially automated logon to the one or more social network sites using user services platform account authentication credentials.

21. An apparatus of claim 17, wherein the apparatus is further caused, at least in part, to:
generate, at least in part, a prompt for accessing the content at the one or more social network sites user accounts; and
cause, at least in part, access to the content by the visiting user using the prompt.

22. An apparatus of claim 17, wherein the apparatus is further caused, at least in part, to:
select one or more social network sites for establishing one or more new user accounts for the social network sites or for logging on to the one or more social network site user accounts.

23. A computer-readable storage medium carrying one or more sequences of one or more instructions which, when executed by one or more processors, cause an apparatus to at least perform the following steps:
receiving an authentication request from a services platform;
retrieving local credentials to authenticate access to a storage;
authenticating the access to the storage based, at least in part, on the local credentials;
if authenticated, determining that account information for the services platform is in the storage, the account information including authentication credentials associated with the services platform, a security policy associated with the services platform, or a combination thereof; and
generating a response to the authentication request based, at least in part, on the account information.

24. A computer-readable storage medium of claim 23, wherein the generating of the response is further based on authenticating the services platform.

25. A method comprising facilitating access, to at least one interface to allow access to a service via at least one network, the service configured to:
cause, at least in part, actions that result in sending to a device an authentication request;
cause, at least in part, the device to retrieve local credentials to authenticate access to a storage;
cause, at least in part, the device to authenticate the access to the storage based, at least in part, on the local credentials;
if authenticated, cause, at least in part, the device to determine that account information for the services platform is in the storage, the account information including authentication credentials associated with the services platform, a security policy associated with the services platform, or a combination thereof; and
cause, at least in part, the device to generate a response to the authentication request based, at least in part, on the account information.

26. A method of claim 25, wherein the service is further configured to:
cause, at least in part, the device to determine that the security policy allows including the authentication credentials in the response;
cause, at least in part, the device to include the authentication credentials in the response; and
cause, at least in part, granting of access rights to the device based on the response.

27. A method of claim 1, further comprising:
causing, at least in part, update of user content consumption history information for one or more users at respectively one or more social network site user accounts; and
causing, at least in part, promotion of the content to one or more visiting users at one or more social network sites.

28. A method of claim 27, further comprising:
determining that a content request has, at least in part, originated from the visiting user's social network site account; and
attributing reward credit to the account of the user in response to the content consumption by the visiting user.

29. A method of claim 27, further comprising:
causing, at least in part, substantially automated user account creation at a services platform using user social network sites account profile data; or
causing, at least in part, substantially automated logon to the services platform using user social network sites account authentication credentials.

30. A method of claim 27, further comprising:
causing, at least in part, substantially automated user account creation at one or more social network sites using user services platform account profile data; or
causing, at least in part, substantially automated logon to the one or more social network sites using user services platform account authentication credentials.

31. A method of claim 27, further comprising:
generating, at least in part, a prompt for accessing the content at the one or more social network sites user accounts; and
causing, at least in part, access to the content by the visiting user using the prompt.

32. A method of claim 27, further comprising:
selecting one or more social network sites for establishing one or more new user accounts for the social network sites or for logging on to the one or more social network site user accounts.

33-77. (canceled)
